(19) United States
(12) Patent Application Publication
(10) Pub. No.: US 2012/0044837 A1
(43) Pub. Date: Feb. 23, 2012

(54) DATA FRAME ROUTING METHOD AND NETWORK BRIDGE

(75) Inventors: Guillermo Agustin Ibanez Fernández, Alcala de Henares (ES); Juan Antonio Carral Pelayo, Alcala de Henares (ES); Alberto García Matínez, Alcala de Henares (ES); Arturo Azcorra Saloña, Alcala de Henares (ES)

(73) Assignees: UNIVERSIDAD CARLOS III DE MADRID, Getafe (ES); UNIVERSIDAD DE ALCALA DE HENARES, Alcala de Henares (ES)

(21) Appl. No.: 13/203,152

(22) PCT Filed: Feb. 23, 2010
(86) PCT No.: PCT/ES2010/000075

§ 371 Date: Nov. 7, 2011

(30) Foreign Application Priority Data
Feb. 24, 2009 (ES) P200900508

(51) Int. Cl. H04L 12/44

(52) U.S. Cl. 370/256

(57) ABSTRACT

A method operates at the data link level. Each bridge associates, during a guard time, the port through which a frame is first received with a source MAC address until a unicast reply frame confirms the matching two-way path between the source and destination addresses. Any frame from the same source received through another different port is discarded. Each bridge forwards the received broadcast frames through the rest of the ports, except those involving prohibited (down-up) turns, and deviates (or optionally returns) the unicast frames with an unknown or aged destination address through the spanning tree. The protocol can operate with encapsulation in the border bridges or without encapsulation, using in this case the replacement of universal MAC addresses in the border bridges with local MAC addresses. The establishment and control of paths can optionally be performed proactively by the border bridges, especially the bridges connected to servers.

### TECHNICAL FIELD OF THE INVENTION

The present invention is comprised in the field of information and communications technologies in general, being more particularly applied for local area networks (LAN) and metropolitan area networks (MAN), such as Ethernet campus networks for example.

### BACKGROUND OF THE INVENTION

The campus networks implemented for the connection of teaching and research centers are currently high-speed backbone networks (Gigabit Ethernet, . . . ), integrating different environments and services (voice, data, video) in a single IP (Internet Protocol) infrastructure, supporting transmission distances which can go from the local field to ranges identical to those of wide area networks (WAN).

The routing of frames in network bridges for interconnecting networks of this type which is currently used is derived from the one defined in the IEEE 802.1D standard. But the use of the current standard Spanning Tree Protocols (STPs) in 802.1D bridges for the implementation of medium- or large-sized networks has the following shortages:
A large amount of expensive infrastructure is underused due to the links blocked by the Spanning Tree (STP) and congestion in the active links occurs.
The IP addresses must be assigned and managed, and the IP address changes when the user changes his connection site.
The switching domains must be fragmented to limit the propagation of problems such as frame storms. To that end, the use of network level routers, or the use of Multilayer Switches for fragmenting into smaller subnetworks, is required.
When virtual LAN networks (VLANs), standardized according to IEEE 802.1Q are used to separate the traffic and the broadcast domains within the switched domain, it is possible to efficiently use the infrastructure, but it is necessary to configure and administer the VLANs, as well as to design and configure the Spanning Trees according to the 802.1Q standard, to then assign the VLANs thereto.
In addition, the Multiple Spanning Tree Protocol (MSTP) technology is a field which has hardly been explored in practice outside the standard (IEEE 802.1s and 802.1Q-2003) and is susceptible to optimization. MSTP is an extension of the Rapid Spanning Tree Protocol (RSTP) which is in turn an evolution of the first specification of the 802.1D standard where STP is defined: RSTP is defined in the 802.1w standard, which became the edition of the year 2004 (802.1D-2004) of 802.1D.

Switches with centralized routing which are used in Autonet [“Autonet: A High-Speed, Self-Configuring Local Area Network Using Point-to-Point Links” by M. Shoreder et al., IEEE Journal on Selected Areas in Communications, Vol. 9, No. 8, p. 1318-1335, 1991] are also known. The routing mechanism used by Autonet is referred to as up/down routing and is based on assigning a direction to all the network links according to the position of the vertex of the link in the distribution tree: up, if it is closer to the Root Bridge (the node of the tree which does not have a parent); down, if it is the opposite. To that end, increasing identifiers are assigned to the bridges starting from the root bridge and descending level by level to the Leaf Bridges (those which do not have children; a node A is parent of B if there is a link of A to node B).The links between nodes at the same height receive the orientation according to whether the identity of the bridge is greater or smaller. A legal route is the one which never uses/crosses a link in the up direction after having used one in the down direction, i.e., loops are prevented by prohibiting down-up turns.

An evolution of up/down routing is formed by the algorithms based on Turn-Prohibition (TP) [for example, “Application of Network Calculus to General Topologies using Turn-Prohibition” by L. Starobinski et al., IEEE INFOCOM 2002 p. 1151-1159, 2002]. Turn-Prohibition algorithms normally operate in two phases: in the first phase the set of prohibited turns is defined and subsequently the routing tables are constructed. The definition of the prohibited turns in turn consists of three phases: construction of the spanning tree, tagging of nodes according to the spanning tree and algorithm for defining the set of prohibited turns.

Another existing solution is the RSJ hierarchical routing (Hierarchical RSTAA-STAR Protocol) which is proposed in the Doctoral Dissertation of G. Ibáñez [“Contribution al diseño de redes campus Ethernet autoconfigurables” (Contribution to the design of self-configuring Ethernet campus networks), Universidad Carlos III de Madrid, 2005; also available in http://enjambre.it.uc3m.es/~gibanez/tesisgif69.pdf].
Nevertheless, the addresses in RSJ have a variable length, and cannot be used within the standard fields of an Ethernet frame, therefore an additional encapsulation of the frame is required. RSJ is an extension of the STAR protocol (Spanning Tree Alternate Routing Protocol) and does not solve the loops by transverse paths in the tree.

Another solution, referred to as HURP [“Hierarchical Up/Down routing architecture for ethernet backbones and campus networks”, Ibáñez, G. A., et al., IEEE Conference on Computer Communications Workshops, INFOCOM, p.p. 1-6, 13-18 April 2008] is a level-two routing architecture which is based on assigning a hierarchical identifier to each node by means of a mechanism associated to the RSTP protocol (“Rapid Spanning Tree Protocol”). It uses an improved version of the up/down (U/D) protocol to prohibit determined turns in determined nodes instead of disabling links (as done by RSTP) to assure loop-free paths. This protocol has an efficiency which is similar to or better than others which are also based on turn-prohibition and it furthermore has a lower O(Nd) complexity and better scalability. HURP improves the efficiency of U/D as a result of the knowledge about the topology of the network provided to it by the hierarchical local MAC (HLMAC) addresses. Thus, the turns reaching either the destination node or the branch of the tree containing the destination are allowed, although they constitute prohibited turns for any forwarding, as a result of the fact that once the frame reaches the destination branch of the tree, it is already forwarded thereon without needing new routing decisions. Each bridge must check if any of its neighbors is a prefix or contains the HLMAC address of the destination, in order to independently forward the turn-prohibition algorithm. This solution uses routing through the transverse links implemented in the control plane (exchange of tables between bridges).

The following are background in the use of faster transverse links in bridge networks:

DLS (Distributed Load Sharing) which is proposed in U.S. Pat. No. 4,811,337, wherein two bridges can agree to route the traffic therebetween through links which do not belong to the spanning tree (transverse links) if said link meets certain conditions: (i) the two bridges at the ends of the selected link implement DLS, (ii) the two bridges of the ends cannot be the predecessor of one another in the spanning tree and (iii) the length of the path associated with the selected link must be less than the sum of the lengths of said bridges to the root bridge. But DLS can overestimate the actual length of the path through the spanning tree, so it can choose links of a longer path. DLS is compatible with the 802.1D standard protocol, therefore the DLS bridges can be deployed in an 802.1D bridge network.

GDLS (Generalized DLS) which is proposed in U.S. Pat. No. 5,150,360 is an extension and simplification of the previous proposal to prevent several drawbacks of DLS, removing the conditions established in DLS for the use of transverse links (not belonging to the tree) upon allowing each transverse link to be choosable for forwarding frames. GDLS does not compare the length of the transverse link with that of the path via the tree, but rather it estimates the transmission rate between trees by measuring the delay by means of a specific data frame of the protocol (BPDU: Bridge Protocol Data Units) exchanged between the GDLS bridges of the ends. By means of this frame, the delay via the tree is compared with the delay through the transverse link and the link with the smallest delay is selected. GDLS is backward compatible with the IEEE 802.1D protocol.

OSR (Optimal-Suboptimal Routing) [“Extended bridge algorithms for large networks” Sincoskie, W. D.; Cotton, C. J.; IEEE Network, Vol. 2, Issue 1, p.p. 16-24, 1988) is a bridge protocol with learning such that optimal or suboptimal routes between bridges can be identified. The bridges located at the end, leaf bridges, learn the MAC addresses of the connected hosts and broadcast them by distributing them hierarchically upwards in the tree in an iterative manner. The bridges listen to the received frames to locate stations in the LAN to which they are connected. They then transmit this knowledge to the bridges located uppermost in the tree and so on until reaching the root bridge by means of OSR location messages. These location messages are transmitted by all the ports of each bridge, even the blocked ones. Each bridge calculates the route to know which link to use in order to reach each destination station through a shortest path. If there is more than one optimal route, the traffic is distributed among them. The OSR bridges encapsulate the frames with a header with a special multicast destination address for all the OSR bridges. The protocol is backward compatible with IEEE 802.1D.

The Bertsekas proposal [“Data Networks”, Bertsekas, Dimitri P.; Gallager, Robert G.; ISBN-10: 0132009161, chapter 5, “Routing in Data Networks”, page 370, 1992] also deserves special attention as background among the existing solutions for the choice of the fastest path. Bertsekas proposes broadcasting packets by means of a tree rooted in a broadcast source node (node A). Each node knows its predecessor or parent in the tree, but does not need to know its successors or child. The tree can be used to route packets from other nodes to node A using the paths of the tree in the opposite direction. It can likewise be used to flood packets from node A. The flooding rule is the following: a packet received from the parent is forwarded to all the neighbors except the parent, all the other packets are ignored. A node only forwards the packets received from its parent node, the other packets are ignored. Sequence numbers in the packets are not needed to detect duplicates because the packets are only broadcast through the tree in the direction away from the root bridge, therefore there are no loops.

The flooding of packets proposed by Bertsekas can be used to construct a tree rooted in a node A such as the one mentioned. Node A starts the process by sending a packet to all its neighbors and the latter forward it to their neighbors and so on. Each node marks the transmitter node of the first packet that it receives as its parent or predecessor in the tree. The nodes must forward the packet to their neighbors only once (after receiving the packet from their parent), all the successive packets must be ignored.

The Bertsekas routing technique has certain deficiencies:

It does not solve the problem of establishing a symmetrical unicast two-way path, i.e., passing through the same nodes in both directions, an essential aspect for the learning of MAC addresses to work and be able to be applied in transparent bridges with learning, an application which is not contemplated by Bertsekas.

It does not use the learning of source node addresses but rather the construction of a tree by means of the learning of the parent node (immediate predecessor), not of the root node of the tree, nor of the issuing host of the frame.

It does not solve the unicast routing between a node A and a node D when backward learning is used. Bertsekas contemplates the broadcast from the source A to the destination D and a unicast routing from D to A, but not with backward learning between A and D because, in the event of a possible variability of the delays in each link in both propagation directions, it may be possible for a path to be selected as the shortest path in one direction which is different from the one in the opposite direction.

It does not solve the problem of the routing between hosts and does not mention any up-down mechanism for preventing transient loops which can occur accidentally or during the construction transients of the tree.

It does not solve the problem of reconfiguration of the tree in the event of failure of a link or node and the transients thereof. It does not explain how to detect a failure of a link or node or how to modify the tree after a failure.

A last recent proposal is the Universal Ethernet Telecommunications Service (UETS) switch described in ES 2246702. UETS switches also have certain restrictions of compatibility with IP and universal Ethernet MAC networks. Standard bridges (802.1D) cannot coexist in a compatible manner within a UETS domain. The UETS and Ethernet domains are disjointed and the frames at the input are classified and sent to one domain or the other. The UETS switches require assignment of hierarchical OSI layer-two addresses and masks of a configurable length according to the physical topology of the network, being assigned by means of management, which involves a complex configuration system. To obtain the local Ethernet addresses of the devices in a UETS domain it is necessary to resolve the domain identifier or the IP address in a UETS Ethernet DNS server. The ARP mechanism [defined in RFC 826 “An Ethernet Address Resolution Protocol”, 1982] cannot be used to obtain said addresses. UETS switches do not contemplate the use of broadcast and multicast. UETS is aimed at Banyan type switches for maximum efficiency which do not use broadcast, a mechanism which is the base of the spanning tree.

In short, the problem which is still not completely solved and is a purpose which the present invention attempts to solve, defining added functionality Ethernet switches and the operation protocols thereof which allow preserving the advantages of known network bridges and which at the same time eliminate their drawbacks, is to implement high-use and high-capacity Ethernet networks which are as self-configuring as possible. Likewise, maximizing the use of the communications infrastructure by means of using simple protocols and with a reduced equipment cost, as well as simplifying the network maintenance and configuration processes, preventing the administration of IP addresses in campus networks and their dependence on the connection site of the host, are objectives of the invention which is described below.

### DESCRIPTION OF THE INVENTION

The present invention solves the problem set forth above in each and every one of the different aspects mentioned, conceiving a routing protocol which operates in the user plane (routing data frames) within the data link level (second OSI layer).

In this context, that of the routing protocols mentioned herein:
control plane is understood as the plane relative to the protocol control messages exchanged between nodes, such as bridge protocol data units (BPDUs, defined in the 802.1D standard).
user plane refers to the frames sent by the users and routed by the nodes.

The data frame routing protocol which is proposed, herein called FastpathUD protocol and thus referred to hereinafter, in turn comprises:

A protocol for the creation (or establishment/construction) and maintenance (configuration and reconfiguration) of a spanning tree assigning consecutive addresses in an ordered manner to the network bridges according to their increasing distance or cost to the root bridge of the tree.

A transparent routing and forwarding protocol, for example using up-down routing using wide broadcast through the entire network of the data frames used to establish a path. The protocol performs a complete broadcast (replacing the limited broadcast through the spanning tree) which is only restricted by the prohibited turns in the topology to prevent loops. Furthermore, this routing and forwarding protocol uses restricted backward learning, which operates by registering or associating the port of each multiport bridge (switch) through which a frame at the source MAC address of the frame has first been received. This backward learning is applicable to both universal MAC (UMAC) and local hierarchical MAC (HLMAC) addresses.

The protocol for the creation and maintenance of the spanning tree assigns addresses (identities) to the nodes (network bridges) of the tree according to increasing distance to the root node (bridge). One embodiment option is to assign local MAC addresses in a hierarchical manner to the bridges by means of the HURP protocol [“Hierarchical Up/Down routing architecture for ethernet backbones and campus networks”, Ibanez, G. A., et al., IEEE Conference on Computer Communications Workshops, INFOCOM, p.p. 1-6, 13-18 April 2008]. In this case, a hierarchical local MAC (HLMAC) address is also assigned to the ports of each bridge. The host connected to a port receives the address assigned to the port connecting the host to the bridge.

The frame routing and forwarding protocol carries out the association or learning for each bridge of the source MAC address of a frame with the port through which it is first received, generating a tuple or entry (for example, in an internal memory of the bridge) comprising at least:
the (48) bits of the source MAC address,
the port address (identity) assigned by the protocol for the creation and maintenance of the spanning tree,
a guard time of the address indicating that the entry (the corresponding memory position) is blocked for the learning process (attached to the associated port)
a retention or aging indicator of the learnt address.

The guard time and the aging indicator act as timers. The guard time has associated thereto a time interval (capture, guard or blocking time), sized such that the delayed reception of a frame with the same source and the one which activated the learning by another port of the bridge are prevented from causing the relearning of said source address but by associating it with another port. When, during the guard time, a unicast frame is received in the opposite direction and with the learnt address as the destination address, the learning of the address in that port is confirmed and at the same time the unicast source address is associated with the port through which it was received. The two-way connection between said unicast addresses has been established in this bridge. The bridge can use that information for forwarding frames. If the reply unicast frame is not received in the guard time interval, the entry corresponding to the address the retention interval of which has expired is deleted in the cache. The guard time is sized according to the maximum expected delay of reply from the network to an ARP packet.

The aging or retention indicator operates as in a standard bridge: it is the interval during which the address is maintained learnt without being refreshed. Thus, if an interval greater than that of the aging of the entries has lapsed without the timer having been renewed, since no frame with said source address has been received, the aging indicator is set to zero to indicate that the source MAC address-port of the bridge association is aged out. The aging or validity time of the frame is marked from the arrival time of the frame through the port which can also be registered in the entry (tuple).

The association between source MAC address-input port can be performed by means of a cache table or memory, optionally of the Content Addressable Memory (CAM) type, which is accessed through the content of the 48 bits of MAC address. The routing and forwarding protocol creates an entry in the CAM containing the associated port identity and the aging and address retention indicators. The retention indicator prevents the memory position from being able to be updated with another port during the guard time (that position is blocked in that time) and does not allow writing the input address (source MAC) in another part of the memory either.

The noting in the table of an entry (tuple) activates the programmable guard timer which blocks said entry and prevents its update, particularly the value of the port identity through which the frame was received (learnt). When a source MAC address associated to the input port is noted (learnt) in the cache table, said source address-input port association is blocked, i.e., it cannot be modified during the blocking/guard time and new associations of said MAC address with other ports of the same bridge cannot be created.

From each bridge, the frames received with a broadcast destination address are forwarded, not only through the ports enabled by the spanning tree protocol, but rather they are forwarded through all the ports of the bridge, except the port through which the frame was first received in the bridge and through the ports which involve performing a prohibited turn (down-up turn) on the frame.

In each bridge in which a frame is received, only one entry is noted in the cache (table or another type of register in the bridge) with the source address of the frame, when there is previously no entry with the same source address and in such case, the identity of the input port of the frame and the instant of its arrival are registered. A frame identifier resulting from a logic operation with some or all the values of the fields of the received frame (for example, the field of the destination address) can optionally be assigned to be used in the access to the entry.

In each bridge in which a frame is received, all the identical frames (with the same content) which are received during the blocking interval (guard period) through ports different from the one which caused the registration of the (same) source MAC address in the cache table are discarded. Similar frames (those which give a matching result upon performing a logic operation thereon, such as the checking of the same source address) are also discarded.

The received frames have a destination MAC address, which can be a broadcast address or a unicast address (which address corresponds to a single host) among other possible destination addresses.

The bridges supporting the proposed protocol (FastPathUD bridges) offer two alternatives for forwarding the unicast frames which they do not know.

In the first alternative, unlike the 802.1D standard bridges, the FastPathUD bridges do not forward the received frame through all the remaining ports (when the destination MAC address is not associated with any port in the cache or has aged out), but rather they modify and return the frame through the received port towards the border bridge which issued it, exchanging the source and destination addresses thereof and modifying a field indicating aged route. This method for unlearning routes by means of returned frames is detailed below.

A destination border bridge (also referred to as designated bridge) is understood as the bridge directly connected to the destination host and which is responsible for sending and receiving its frames. The destination border bridge of said frame performs a new route establishment by means of a broadcast frame with the address of said bridges as the source address. Optionally, each receiver bridge of a broadcast frame responds to said frame through the port where it was first received with a new partial path establishment frame, the source address of which is the address of said bridge and its destination address is the address of the source border bridge, the bridge connected to the source host of the received frame. This optional mechanism allows consolidating the paths between intermediate bridges and the source border bridge for their use by other frames.

In the second alternative, the FastPathUD bridges receiving a frame with an unknown unicast destination address tag it with a VLAN identification (which can be the default VLAN ID) and forward it through the spanning tree in the 802.1D standard manner, FastpathUD path establishment not being performed in the rest of the course. The frames diverted from the course through the tree travel over the spanning tree by means of a broadcast mechanism with or without (according to the configuration or implementation option) standard backward learning of the source address. If backward learning is used in the spanning tree, the reply frames travel over the same path as the received frames in the reverse direction, the first part over the spanning tree through the links through which the address was learnt and once the FastpathUD bridge which performed the deviation on the spanning tree is reached, they travel over the FastpathUD path to the source host. If backward learning is not used, the frames are broadcast through the entire spanning tree until reaching the destination host.

Additionally, the routing and forwarding protocol for routing and forwarding the data frames in a border bridge can encapsulate them with a header the source and destination fields of which are a hierarchical local MAC (HLMAC) address, which the addresses of the bridges and stations connected to the border bridge is contained as a prefix. In this case, the border bridge chooses a destination among its available routes, selecting that bridge the prefix of which shared with the address of the destination host is longest and has an active route.

The FastPathUD path creation and maintenance protocol likewise allows the configuration and reconfiguration of symmetrical paths in the bridge network by means of periodically sending frames between border bridges which keep the paths between them learnt with additional mechanisms for checking the stability and symmetry of the path between the bridges in both directions. The bridges optionally send tracer packets or frames, periodically in predetermined sequences known by all the bridges, which allows the receiver bridges to verify the availability, stability and optimization of the fast route upon comparing the results of the reception of the same tracer packet through various ports. The tracer packets have as the source address each of the FastPathUD border bridges and can have as the destination address the address corresponding to a single destination border bridge (unicast) to maintain an established path between bridges, or a broadcast address.

Additionally, the FastpathUD protocol uses turn-prohibition mechanisms to prevent loops in the broadcast of frames. The use for the control of the turns of the addresses assigned in order by the distance of each node/bridge to the root node prevents the need to execute a centralized algorithm in the network which determines the allowed and prohibited turns. The method for preventing loops by turn-prohibition is independently executed in each node from: its assigned address (for example, HLMAC), those of the previous and following nodes in the route and, optionally, for optimization, the source and destination addresses of the frame. The bridges prevent executing the prohibited turns on the user frames although this entails not using a shortest path.

Since the FastPathUD protocol assigns the identities according to increasing distance to the root bridge, the address (identity) of the node/root bridge is always the smallest one and increases upon going down the tree, which assures a high effectiveness in the turn-prohibition and that the network is not disconnected. It is thus always possible to reach any node of the network through paths formed by arbitrary combinations of up/down, up/up and down/down turns, but without any down/up turn, the latter assuring the non-existence of loops.

Likewise, the described routing protocol also includes:

An optional unlearning (deletion) process for learnt routes by means of frames returned towards the source MAC address through the bridge receiving them, modifying the frame to be returned (in a field such as the bit or VLAN identity) with universal MAC or local HLMAC addresses.

The unlearning process optionally intervenes in the reconfiguration of the network. The unlearning (deletion) process by means of returning the frames with addresses affected by a reconfiguration can be caused by a crash of network bridge, link (belonging or not belonging to the spanning tree) and optionally by the aging of the addresses if the forwarding through the spanning tree of the frames with a unicast address unknown by the bridge is not used.

The FastPathUD protocol allows the reconfiguration of the network due to a crash of a link, which belongs or does not belong to the spanning tree. In all the cases, the standard mechanism for deleting learnt MAC addresses is applied for the deletion of universal or local MAC addresses learnt in the ports (standard function of the 802.1D bridges) as well as of the local addresses (or hierarchical local addresses: HLMAC) assigned to the bridges with the aid of the RSTP protocol. During the reconfiguration of the spanning tree, the forwarding of frames through the ports is blocked according to said protocol. The control of up/down turns is likewise linked to the reconfiguration of the RSTP protocol, given that the local/HLMAC addresses are assigned according to said protocol. When the root port of a bridge is enabled by the RSTP protocol is when the bridge acquires a local address valid for the purpose of controlling up/down turns.

In the event that the reconfiguration of the network occurs through the crash of a link, it becomes necessary to delete the addresses learnt in the two ports of the link. When the crash of the link is detected, locally or through the RSTP protocol, the bridges of its ends act by deleting all the addresses learnt by means of FastPathUD in the port connected to said failing link. When a unicast frame is received with a destination according to one of the two possible implementation variants which are described for the unlearning mechanism:

i) Preferred implementation of the unlearning when UMAC addresses are used: Using a BPDU of the FastPathUD protocol within the Ethernet type corresponding to the 802 standard protocols. This BPDU uses as the destination address the multicast group address of all the FastPathUD bridges and uses the same LLC encapsulation (IEEE 802.2 heading LLC: “Logical Link Control”) as the spanning tree BPDUs. The BPDU of the FastPathUD protocol also includes, in the data payload, the destination address of the deletion packet and the unreachable address or addresses. Each bridge receiving said BPDU processes it, deleting said addresses from the cache of its port where they were still valid, and immediately forwards it to the following bridge in the return path of the frame to its source.

ii) The other implementation variant, possible when using HLMAC addresses having free bits in their least significant part consists of using data frames with the least significant bit of the source address (bit located at the right end of the local or HLMAC address, separated from the valid HLMAC address by one or more bits at zero) activated to “1”. This value of said bit is interpreted by the crossed FastPath bridges as address unlearning. When a bridge receives through a port a frame directed to an address which was learnt in said port, it returns it through the port where it was received but converted (putting the least significant bit of the source address to “1”) into a path deletion (address unlearning) frame. To return the frame, the bridge furthermore modifies it by putting as the destination address the source MAC address that it contained (the address of the input bridge if encapsulation in the input FastPathUD bridge is used) and the bridge puts its own address (HLMAC or sequential local identifier assigned with RSTP) to replace the source address of the frame. The bridge sends the deletion frame through the port through which it was received, traveling over the reverse path and deleting its source address from the caches of the input ports of the crossed bridges. When the input border bridge verifies that the deletion frame is directed to it, it establishes by means of ARP a new path to the destination by means of broadcast, reconverts the frame to its original format and forwards it to the destination host through the new path found. In this implementation, if there is encapsulation, the destination address of the frame is that of the border bridge, or the HLMAC address of the destination host, if there is no encapsulation. When the border bridge detects the unlearning bit and its address matching the destination host in the prefix, it intercepts the frame, processes it by deleting the learnt address or addresses, activates a new process for the creation of a two-way path to the destination host and discards the frame.

In the RSTP protocol, in a link belonging to the RSTP spanning tree, the port connected to the parent bridge (the upper one in the spanning tree) has the designated role and the port to the child bridge has the root port role. In the particular case of the reconfiguration occurring through a crash of a link belonging to the spanning tree, a new designated and root port must be chosen in the affected bridges. The corresponding ports are blocked, which ports are enabled once the agreement between the two bridges involved has been completed: designated port of the hierarchically superior bridge and root port of the connected hierarchically inferior bridge, within the hierarchical spanning tree. The involved branches delete the learnt UMACs. The reconfiguration which is broadcast through the network by the indicator bits (flags) of the BPDU (in the flag bits indicating a Topology Change notification) in a manner similar to RSTP, causes the deletion of the local addresses in all the bridges and from the port caches thereof. The deletion of addresses (by means of MAC flush) can be total or partial. When each bridge receives the topology change notification, it deletes the local addresses and blocks the sending of user frames until the spanning tree is enabled.

The reconfiguration of the network caused by the crash of a bridge with the FastPathUD protocol is also possible. In this case, if the bridge is not a leaf bridge, the spanning tree crosses it, therefore a reconfiguration similar to that described above occurs, but affecting all the links of the bridge.

Additionally, the return of the frames for unlearning can include encapsulation in the border bridges.

The reconfiguration of the network is indirectly controlled by the rapid spanning tree protocol, RSTP [IEEE 802.1D 2004]. This protocol is used in FastPathUD bridges as an auxiliary protocol as a basis for the assignment of HLMAC local addresses, the validity instant thereof and the reconfiguration of roles and statuses of the ports. A bridge has a valid HLMAC address in the moment in which its root port establishes the agreement of passage to a forwarding status with the designated port of the parent bridge. The remaining ports of the bridge will have the designated, alternate or back-up role. The designated ports in turn repeat the 802.1D standard process for proposal and agreement with the root ports of the child bridges in the tree. Thus, the root and designated ports of each bridge use the RSTP mechanism for passing to a forwarding status.

The ports with the alternate or back-up role are those corresponding to the redundant links, also called cross-links (joining different branches of the spanning tree or nodes of one and the same branch) and are those which are normally blocked by the spanning tree protocol, but which the FastPathUD protocol allows using, respecting the restrictions of up/down turns to prevent loops. These ports pass to a forwarding status (forwarding) by means of a process similar to that of RSTP, of proposal and agreement with the port connected to the other end of the link by means of the bits of proposal and agreement of the BPDU of RSTP. But for the agreement of passage to a forwarding status to be established, both bridges must have a valid HLMAC address and must have completed their reconfiguration, i.e., all their designated ports must have reached the forwarding status and, furthermore, a configurable timer of the bridge started when all the designated ports completed their passage to forwarding, must have expired. This timing assures the stability of the HLMAC addresses in the entire network when the ports of the cross-links (with Alternate and Back-UP roles) are enabled.

In the event of failure of a link belonging to the spanning tree, the root port of the child bridge loses its root role and said bridge selects as the new root port the port receiving a better BPDU of all of them. The passage to forwarding said root port validates the assignment of the new HLMAC to the child bridge recently connected to the new parent bridge. The designated ports transmit their new HLMAC address downwards. The entire branch of the tree dependent on the child bridge modifies its HLMAC address in accordance with the new HLMAC prefix of the child bridge.

In the event of failure of a link not belonging to the spanning tree (cross-link), the two ports connected to said link pass all the connections and addresses learnt to an unreachable address status and when the respective bridges receive packets intended for those unreachable addresses, they return in the form of an unlearning packet NACK(destination) each received packet having as the destination a host or bridge previously learnt as unreachable through the failing port. When a unicast data frame with source S and destination D with an unreachable address reaches the bridge, the bridge replies by sending backwards a packet NACK(D) aimed at the border node (or source host in the event that encapsulation is not used), indicating to the preceding bridge the unavailability of a path towards the destination D. When this bridge receives the packet NACK(D), it puts the address D as unreachable and resends the packet NACK(D) backwards until reaching the source border bridge, which establishes a new path to the destination D by means of an “ARP Request” packet.

The protocol described herein allows extending and modifying the 802.1D standard protocol, increasing its efficiency until placing it close to that of a shortest path protocol. Furthermore, FastPathUD continues using the ARP standard protocol for the resolution of the IP address to the MAC address, whether it is universal (UMAC), local or local and hierarchical (HLMAC) address.

According to the use of the addresses to establish the paths by the FastPathUD protocol, there are various alternative modes of operation which are described below.

A) Operation without Encapsulation with Universal MAC (UMAC) Addresses

In this mode of operation, the Ethernet frames sent by the hosts with UMAC addresses are not modified by the border bridges.

The source station or host S sends an ARP packet (or another packet with similar functionality containing the destination IP) with a layer-two broadcast address (FF:FF:FF:FF:FF:FF).

The designated border bridge of the host (input bridge to the FastPathUD network) receives the “ARP Request” packet and retransmits it through all the ports except the input port. The bridge learns the source UMAC address (of the issuing host) and associates it with the port through which it was received, also opening a provisional connection linked to the sourceIP-destinationIP pair contained in the “ARP Request” packet. That sourceIP-destinationIP connection is confirmed when the bridge receives an “ARP Reply” packet replying to the destination host through the return path.

For the purpose of assuring the path symmetry and preventing the casual simultaneous establishment of two paths, when a border bridge issues a “ARP Request” packet through its ports, it activates a timer during which it retains it and if it receives any “ARP Request” packet in the reverse direction (i.e., with the same pair of IP addresses but in opposite sourceIP-destinationIP positions with respect to the ARP packet issued by the source border bridge, it does not reply for the purpose of preventing the establishment of a non-symmetrical path, not matching in both directions between the source and destination).

The intermediate bridges (those which are not border bridges) operate in the same manner and additionally, if while the connection is in a provisional status in an intermediate bridge, an “ARP Request” packet containing the same pair of addresses as sourceIP-destinationIP (regardless of whether they appear as source or destination) is received through the same or a different port, this packet is ignored in terms of establishing a new provisional connection.

Then, the “ARP Request” packet is forwarded through all the ports allowed by the up/down turn-prohibition until reaching the hosts. The provisional connection is maintained for a time sufficient to receive the “ARP Request” packet of the destination, which time must be greater than the expected round trip time of the network in high payload conditions. Upon receiving through one of its ports the “ARP Reply” unicast packet with the source UMAC address of the “ARP Request” as the destination and corresponding to the IP_source-IP_destination pair of the provisional connection, the bridge fixes connection by associating the source and destination UMAC addresses with the tables of the respective ports and deleting the provisional connection created.

If the terminal does not send an ARP packet (due to having the destination in its ARP table (the table where the host stores the identities, IP addresses and MAC addresses of the recently used or preconfigured destination hosts) or due to another reason, and the border bridge has no known path to the destination, the bridge retains the unicast packet, generates and sends an “ARP Request” packet to establish the path and, once replied to, forwards the unicast packet through the created path. Optionally, the bridge can send the packet through the spanning tree in a conventional manner, tagging it with the corresponding VLAN.

B) Operation with Hierarchical Local Addresses (HLMACs) without Encapsulation and with Substitution of UMACs

In this implementation, the source host also uses universal MAC addresses, but the frames are not encapsulated in the border bridge but rather the latter replaces the source universal MAC with the HLMAC of the port connecting the host to the border bridge. The hierarchical nature of the HLMAC addresses, whereby the HLMAC address of the input bridge is a prefix of the addresses of the hosts connected thereto, enables in this case the establishment and control of paths between the bridges and the aggregation of various routes between hosts through said paths.

The operation of the path establishment by means of ARP packets or frames is as follows:

The terminal sends an ARP frame (or another frame with similar functionality containing the destination IP) with broadcast address (FF:FF:FF:FF:FF:FF). The border or designated bridge (input bridge to the FastPathUD network) receives the ARP packet, replaces the UMAC of the field source in the Ethernet frame with the HLMAC address of the host (which is simply identical to the HLMAC address of the border bridge extended with the port number joining the bridge to the host), recalculates the verification code and retransmits it through all the ports except the input port. The bridge learns the UMAC address and associates it with the port through which it was received and therefore with the HLMAC assigned to the host. The bridge creates a provisional connection (joining of two source and destination hosts) identified by the sourceIP-destinationIP pair contained in the ARP packet, which connection is confirmed upon receiving the “ARP Reply” packet replying to the destination host through the return path, which must use exactly the same links as the forward path, from source to destination. Said connection is only created if it has not been previously created, as indicated below.

The bridge forwards the ARP broadcast packet modified with the UMAC address of the source host substituted with the HLMAC address, through all its ports except the input port and those involving a prohibited turn. Each bridge receiving the ARP packet likewise opens a provisional connection linked to the sourceIP-destinationIP pair. If while the connection is a in provisional status an ARP with an identical or reverse sourceIP-destinationIP (exchanged IP source and destination) is received through the same or a different port than the existing connection, this packet is ignored in terms of establishing a new provisional connection and it is forwarded, if it is not a packet detected as a duplicate packet, through all the ports allowed by the up/down turn-prohibition. The provisional connection is maintained for a time sufficient to receive the network the “ARP Reply” packet of the destination under normal operation, which time is greater than twice the worst-case maximum round trip time. Upon receiving through one of its ports the “ARP Reply” unicast packet containing as the destination address the source MAC address of the “ARP Request” and corresponding to the sourceIP-destinationIP pair of the established provisional connection, the bridge fixes the connection by associating the source MAC and destination MAC addresses with the tables of the respective ports and deleting the provisional connection created. This two-way connection requires being periodically renewed in each direction by the traffic with both hosts of the connection as the source and destination. The renewal can operate as in the 802.1D bridges in which the source MAC address renews the cache of addresses of the port where it is received, or in a two-way manner, in which the destination address of the packets of unicast data also act by renewing the timers of the caches corresponding to the source ports (which is referred to as forward renewal).

If the host does not send any ARP packet (due to having the destination in its ARP table or due to another reason), the border bridge receives a packet for the destination MAC of which it has no known output port (route). In this case, the border bridge constructs and sends a prior establishment request packet to establish the path.

C) Establishment and Maintenance of Paths Between Border Bridges with HLMAC

Each border bridge can establish paths with all the other bridges upon being initiated or only when it has an active host connected. The method for the establishment of paths by default is the one described above which is based on the ARP packets sent by the host.

The bridge can alternatively and autonomously send a path establishment packet with its HLMAC address as the source address and with the multicast address encompassing all the FastPathUD bridges as the destination address.

The type of packet can be the “total path establishment request” packet. Each FastPathUD bridge receiving said packet establishes a provisional connection with said border bridge linked to the port through which said path establishment packet was first received. The bridge learns the source HLMAC address of the received frame (that of the source border bridge) and associates it with the port through which it was received. The bridge creates a provisional one-way connection (joining of two source and destination border bridges) identified by the HLMAC of the source border bridge of the connection establishment request packet (COMPLETE_CONNECT_REQUEST), which connection confirms each destination border bridge individually: each bridge receiving said connection request packet generates a partial path confirmation packet (PARTIAL_CONNECT_CONFIRM) with the HLMAC of the intermediate bridge reached as the source address and with the HLMAC of the source border bridge as the destination address. This packet (PARTIAL_CONNECT_CONFIRM) indicates to the source border bridge the progress of the establishment of the provisional connection and confirms the path in the opposite direction hop by hop by associating the

HLMAC address of the reached bridge with the port of each bridge crossed by the confirmation packet towards the source border bridge. When the connection request reaches each of the border bridges of the network, each of them generates a connection confirmation packet (CONNECT_CONFIRM) with its HLMAC address as the source address and the address of the source border bridge of the request packet received as the destination address, and sends it through the same port associated with the request packet received. Since this packet is received backwards, the HLMAC address of the destination border bridge is learnt in the bridges, the provisional connection established in all the bridges being confirmed.

In any of the possible implementations, for the learning of MAC addresses to work, it is necessary for the FastPathUD paths established between border bridges in the network to be exactly symmetrical and cross the same links in the forward and backward direction. The optional establishment mechanism confirmed step by step described above contributes to said purpose. The border bridges use additional mechanisms for controlling the symmetry of the established paths. When a CONNECTION_CONFIRM packet is received through a port, they permanently associate said port with the destination border bridge. To confirm the availability of the path, each border bridge periodically sends PATH_REFRESH refresh and verification packets with each of the destination border bridges as the destination. These packets keep the paths active and allow the bridges to check the availability thereof. Each issuing border bridge expects to receive REFRESH_CONFIRM packets from each destination bridge, marking and confirming the opposite path in each crossed bridge. The issuing border bridge verifies that the receiver port of the REFRESH_CONFIRM confirmation packet is the same port through which the PATH_REFRESH packet was sent. Each crossed bridge also verifies that the receiver and transmitter ports for those destinations match those of the established path. If they differ, the connection is deleted and a REFRESH_REJECT packet is returned towards the source to notify the invalidity and the deletion of the connection and cause the establishment of a new connection.

When the optional confirmation of the path in each bridge is used, upon establishing a path to a border bridge the paths to the intermediate bridges are established. Each bridge notes said paths such that it is not necessary to establish it again.

The main differences of the FastPathUD routing protocol with respect to “hierarchichal” routing which exist in UETS are:

The routing in UETS is based on the progressive decoding of the hierarchical local Ethernet addresses assigned in accordance with the topology of the network. In FastPathUD, the addressing is based on tree and not on the topology, which is only used for turn-prohibition in the prevention of loops.

The addresses in UETS are biunivocally linked to the step-by-step routing and the routing is determined by the assigned addressing. In FastPathUD, the routing is based on learning by the bridges (in the data plane) of the shortest paths within those allowed, established by means of flooding restricted by Up/Down turn-prohibition.

Features, advantages and drawbacks of the different variants of the invention described above, using or not using encapsulation in the routing of the frames, are summarized below. In all the cases, it is assumed that there is deviation of the frames with a unicast address unknown by the spanning tree and that the frames have the VLAN T (“VLAN Tree”) tag corresponding to the tree.

a) Routing without encapsulation and using UMACs in the hosts: The routing of unicast addresses unknown by the spanning tree uses broadcast without learning. The bridges use HLMACs to apply up/down turn control, but it is not possible to route by means of the HLMAC because the frame only has the UMAC.

b) Routing with HLMAC encapsulation and using UMACs in the hosts: In this variant, routing through the tree via HLMACs is possible. The main advantages are: smaller number of MAC addresses to be learnt in each bridge (10-100 factor), a more controlled and robust proactive routing performed by the bridges is possible, and it prevents the unnecessary broadcast of frames through the tree.

c) Routing with ULMAC encapsulation and using UMACs in the hosts: It requires an Up/Down address mechanism and an additional reconfiguration process.

d) Routing with substitution of MAC addresses with HLMAC addresses (NAT process) and using UMACs in the hosts: The HLMAC contains a bridge (prefix) and host (suffix, port number) address. Routing through the tree without broadcast using the HLMAC is possible. It is a proactive routing established by the bridges. The advantages are that it requires a smaller number of MAC addresses to be learnt and only requires learning the prefix of the bridge instead of that of the hosts. Mechanisms for controlling the consistency of the ARP caches in the hosts are necessary.

Briefly, other advantages of the invention over the prior state of the art are:

In comparison with the protocols routing frames, it allows aggregating routes between the border bridges by means of hierarchical addressing.

In comparison with the protocols operating in the control plane such as LSOM (“Link State Over MAC”) and others such as HURP which assign hierarchical local addresses (HLMACs), it does not require the periodic exchange of routes between bridges, operating in a transparent manner by means of backward learning on the data frames.

In comparison with the protocols which are not compatible with the Ethernet frame format, the protocol is compatible.

In comparison with the protocols using additional encapsulation of the frame for the forwarding, it is not essential to perform the encapsulation (tunneling) of the frame for the broadcast in a campus network of switches.

In comparison with the 802.1D standard, it allows using the entire network infrastructure without blocking redundant transverse links, only limiting some turns in the switches.

In comparison with MSTP and the IEEE proposal in 2005 called “Shortest Path Bridging” (http://www.ieee802.org/802_tutorials/july05/nfinn-shortest-path-bridging.pdf), the protocol does not require any method in the control plane for the transverse paths apart from the assignment of addresses, nor does it require the construction of multiple spanning trees or exchange of routes between switches.

As in up-down routing, the paths are close on average to the minimum delay obtained by shortest path routers, because the fraction of prohibited turns with respect to the total of possible turns in the topology is small.

High scalability without obligatory additional encapsulation.

Maintenance of the 802.1D standard broadcast and multicast mechanisms in OSI layer two.

Compatibility with the ARP and DHCP standard protocols and with the current hosts (PC) and servers (Windows in all its versions and Linux) without needing software or hardware changes.

Another aspect of the invention relates to a subnetwork interconnection device, more specifically, a network bridge (“bridge”), herein called FastPathUD bridge, which operates at the data link level (layer 2) according to the network protocol creating the spanning tree used to assign the ordered addresses to the bridges. This device forms a network bridge which is self-configuring and is based on the operation of its ports in at least two modes, simultaneously or alternately: in standard mode as a conventional (802.1D) bridge and in hierarchical mode operating by means of the FastPath protocol.

A further aspect of the invention relates to a switched network with one or more subnetwork interconnection devices forming the proposed FastPathUD network bridges and to which at least one conventional network bridge operating exclusively according to the 802.1D standard protocol can be added.

### DESCRIPTION OF THE DRAWINGS

To complement the description which is being made and for the purpose of aiding to better understand the features of the invention according to a preferred practical embodiment thereof, a set of drawings is attached as an integral part of this description, in which the following has been depicted with an illustrative and non-limiting character:

FIG. 1 shows a block diagram with the main processes of the method for routing, according to a preferred embodiment of the invention.

FIG. 2 shows a schematic tree depiction of a telecommunications network, wherein the nodes of the tree represent network bridges and the connection links between nodes represent the possible paths established.

FIG. 3 shows the format of a BPDU frame of the rapid spanning tree protocol known in the state of the art.

FIG. 4 shows the format of a BPDU frame used by the protocol for the creation and maintenance of the spanning tree, according to a possible embodiment.

FIG. 5 shows an example of assignment of addresses in the spanning tree created according to a preferred embodiment of the invention using hierarchical local addresses.

FIG. 6 shows a schematic depiction of a bridge network and of the routing of frames, according to the object of the invention, to obtain the paths between host stations.

FIG. 7 shows a block diagram of the process for forwarding frames implemented by a network bridge according to a preferred embodiment of the invention.

FIG. 8 shows the process for the establishment of a two-way path using encapsulation with hierarchical local addresses, according to a possible embodiment of the invention.

FIG. 9 shows the process for the establishment of a two-way path without using encapsulation and which substitutes universal addresses with local addresses in the border bridges, according to another possible embodiment of the invention.

FIG. 10 shows the process for the establishment of a two-way path without using encapsulation and using universal addresses, according to another possible embodiment of the invention.

FIG. 11 shows the address unlearning process.

FIG. 12 shows the process for deviation and broadcast through the standard spanning tree of frames with an unknown destination address in an intermediate bridge, according to a possible embodiment of the invention.

FIG. 13 shows the process for routing frames with an aged destination address in the intermediate bridges, using forwarding through the tree in the respective forward and backward directions of the two-way path and decoding HLMAC addresses, according to a possible embodiment of the invention.

FIG. 14 shows the process for routing frames with an aged destination address in the intermediate bridges, using forwarding through the tree in the backward direction of the two-way path and without learning in the intermediate bridges, according to another possible embodiment of the invention.

### DETAILED DESCRIPTION OF THE INVENTION

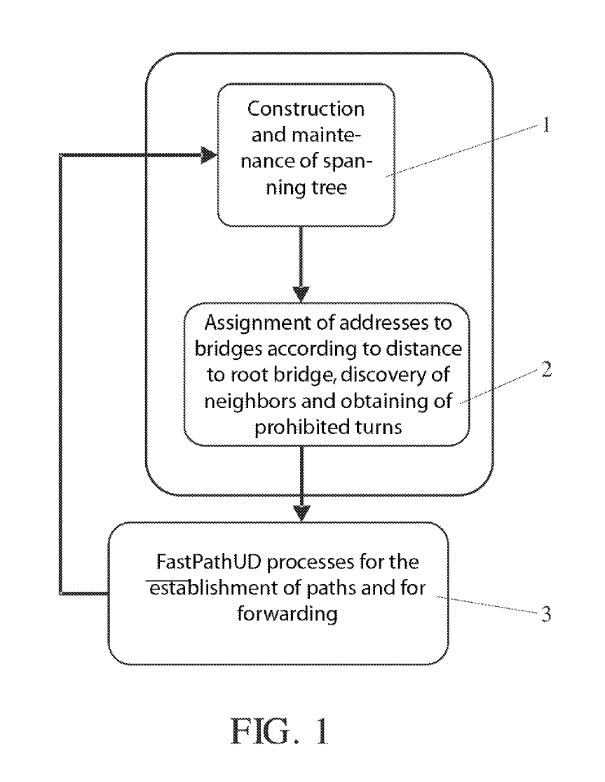

A preferred embodiment of the invention can be described as a layer-two or data link level network protocol, which is executed within a telecommunications network, such as a campus network, in each of the network bridges and which carries out the processes indicated in FIG. 1:
(1) process or protocol for the construction and maintenance of the spanning tree;
(2) protocol for the assignment of addresses to bridges according to distance to root bridge, discovery of neighbors and obtaining prohibited turns;
(3) processes for the establishment of paths and for forwarding frames.

Within the processes for establishing paths, the paths through the spanning tree and FastpathUD paths—paths which are faster than the previous ones—are distinguished.

All these processes (1, 2, 3) are executed to perform the routing of frames according to the method object of the invention, which has herein been called FastPathUD, referring to the network bridges wherein the processes of this method are executed as FastPathUD bridges.

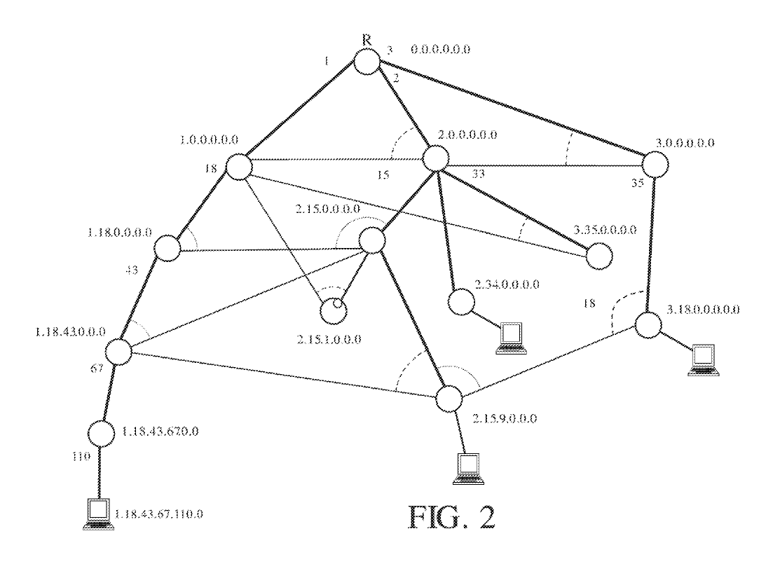

FastPathUD is applicable to a telecommunications network, which can be represented by means of a tree or graph, such as the example shown in FIG. 2, wherein all the nodes, drawn as circles, correspond to FastPathUD network bridges. Hosts connected to respective border bridges are drawn at the end of the tree. Next to the nodes there appear the hierarchical local addresses, HLMAC, as an example, assigned to the bridges. The links of the spanning tree obtained by means of executing the protocol for the creation and maintenance of the tree (1), according to a possible embodiment of the invention, are depicted with a thick line in FIG. 2. Next to the lines representing links of a node, some identifiers of designated ports in the node are also indicated as an example, using numbers in italics.

The compatible interconnection of FastPathUD bridges with the 802.1D bridges can be performed as described in [“Abridges: Scalable, self-configuring Ethernet campus networks”, Ibáñez, G. A., Computer Networks, vol. 52, issue 3, pp. 630-649, 2008]. Thus, in the connection between the different types of bridges, self-configuring mechanisms are used which construct a core of FAstPathUD bridges at the ends of which there are connected standard spanning trees formed by the 802.1D bridges, joined to the FastPathUD border bridges acting as root bridges of the respective spanning trees.

According to a possible embodiment option, the FastPathUD routing protocol makes use of up-down routing based on the HLMAC addresses assigned to the network bridges. In this case, conceptually, a FastpathUD bridge can be seen as a router for frames with hierarchical local Ethernet addresses which can furthermore incorporate the standard functionality of a conventional bridge.

The example network of FIG. 2 shows a series of FastpathUD bridges from which a root bridge R is chosen, assuming that, due to the priority configuration of the bridges, the bridge R is the one having the smallest prefix or identity number of the bridge of the entire series.

The following is constructed from said root bridge R, as shown in FIG. 2:

the 802.1D standard spanning tree, formed by the nodes connected by links depicted with a fine line;

the spanning tree created by means of the protocol (1), with the links in a thick line, wherein the process for the assignment of addresses to bridges (2) is executed, assigning to the nodes local addresses in order based on the distance to the root bridge R; in the example of FIG. 2, the local addresses are hierarchical, HLMAC.

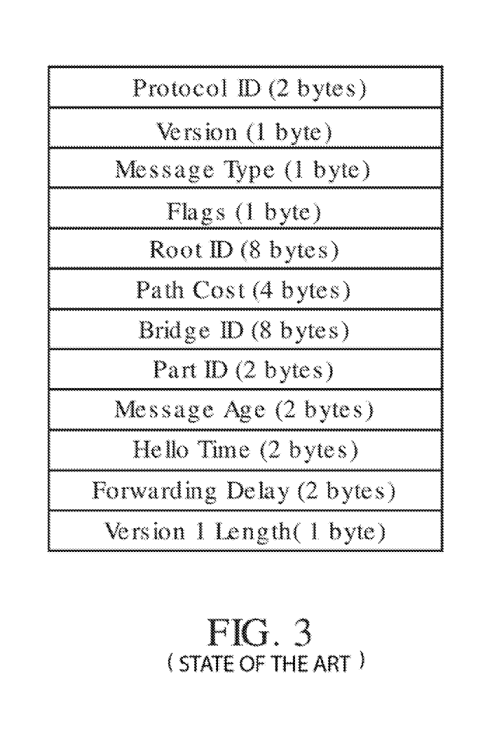

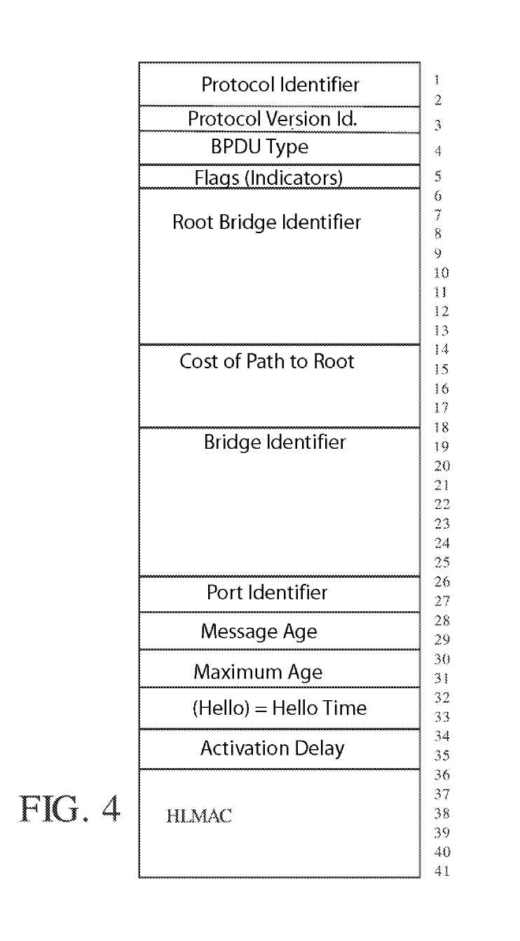

The mechanism for the hierarchical assignment of addresses uses the construction of the standard spanning tree by STP or RSTP. FIG. 3 illustrates the format of a standard BPDU of the RSTP spanning tree protocol. FIG. 4 illustrates its extension, incorporating after the last octet of the standard BPDU six more octets, octets 36-41, in order to include the HLMAC local address of the node identifying it in its connection with a neighboring node through a designated port.

The BPDUs used by the FastPathUD protocol are sent by each FastPathUD bridge to one or several of its neighboring bridges. They have a specific multicast destination address identifying the FastPathUD bridges. Said BPDUs are processed by each FastPathUD bridge and forwarded. Within the BPDU of the FastPathUD protocol there can be included the address of the final destination bridge of the same BPDU, in which case each FastPathUD protocol bridge inspects the frame, executing the appropriate action, such as deleting the connections affected by a failure and then forwards it to the neighboring bridge through the port through which the final destination bridge has been learnt.

In this network, the FastPAthUD bridges can use all the links interconnecting them to route frames, provided that the corresponding turn is not prohibited.

The FastpathUD bridges handle the standard Ethernet frame format without needing encapsulation, within which the destination MAC address and source MAC address fields are in accordance with the 802.1D standard, each field being defined by 48 bits grouped in 6 octets.

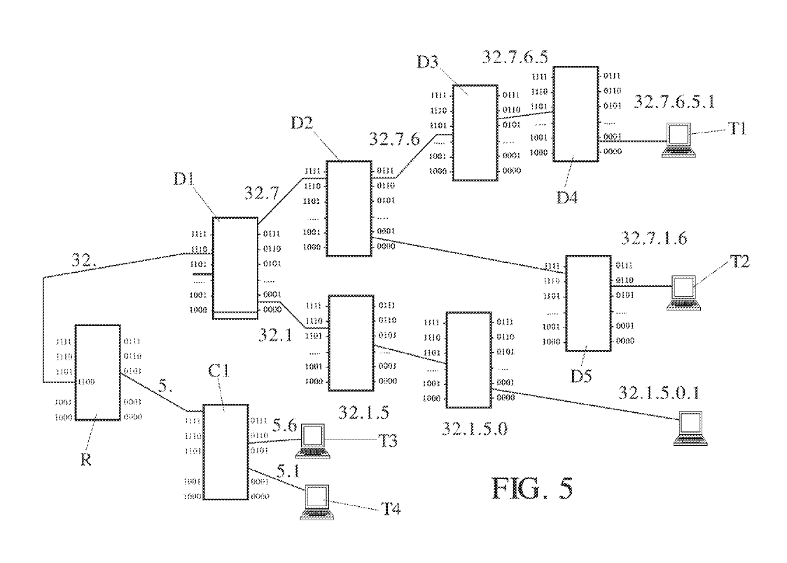

FIG. 5 illustrates an example of assignment of HLMAC addresses to the FastpathUD bridges, using a default configuration of 8 mask bits for each level of the spanning tree after the second level and assuming that the root bridge R of the spanning tree has two ports designated to two respective neighbors (C1, D1) the identifiers/prefixes of which are respectively 5 and 32, for example. The identifiers of the ports of each bridge are depicted in FIG. 5 in binary with 4 bits. The neighboring bridge D2 connected to the bridge D1 through the port 0111 receives a BPDU with a local MAC address with a value of 32.7 and furthermore containing all the information of the STP/RSTP protocol. With this information it assigns the address to its respective designated ports, the port 0110 to the bridge D3 through which it sends a BPDU with address 32.7.6 and the port 0001 to the bridge D5 through which it sends a BPDU with address 32.7.1, having added the identity of the designated port at the end in the respective BPDUs. The width of the mask in bits can depend on the level of the bridge in the spanning tree. The bridges D4 and D5 are connected by their respective ports with identifiers 0001 and 0110 in the example, to hosts, T1 and T2, which in turn finally receive the BPDUs with addresses 32.7.6.5.1 and 32.7.1.6 respectively. The bridge C1 is a leaf bridge which is directly connected to two hosts, T3 and T4, through the designated ports, in the example, 0110 and 0001. The host T3 receives a BPDU with local address 5.6 and the host T4 receives another BPDU with local address 5.1, in correspondence with the prefixes of said designated ports.

When the terminal ports of a FastpathUD bridge are connected to a single host, the designated terminal port can optionally perform the substitution of the source universal MAC address in the incoming frames, data frames which can send the host to the bridge by the hierarchical local MAC address of the designated or input port. This process for the substitution of MAC addresses is referred to in an abbreviated manner as NAT of MACs. The reverse substitution is performed in the frames going back towards the host, reinserting the universal MAC address universally assigned to the host. The ARP protocol is used for the resolution of the IP address to the MAC address in a completely compatible manner, whether it is a universal or a hierarchical local address.

The border bridges can use universal MAC addresses, UMACs, instead local MAC addresses or HLMACs. The process for the establishment of paths is identical to that described for HLMAC addresses, except in that it uses a mechanism for the sequential assignment of identifiers to the bridges according to their increasing distance to the root bridge R in the spanning tree and for the reassignment of addresses in the event of reconfiguration of the spanning tree. These identifiers are used by each node to determine the prohibited and allowed turns therethrough by means of up/down routing.

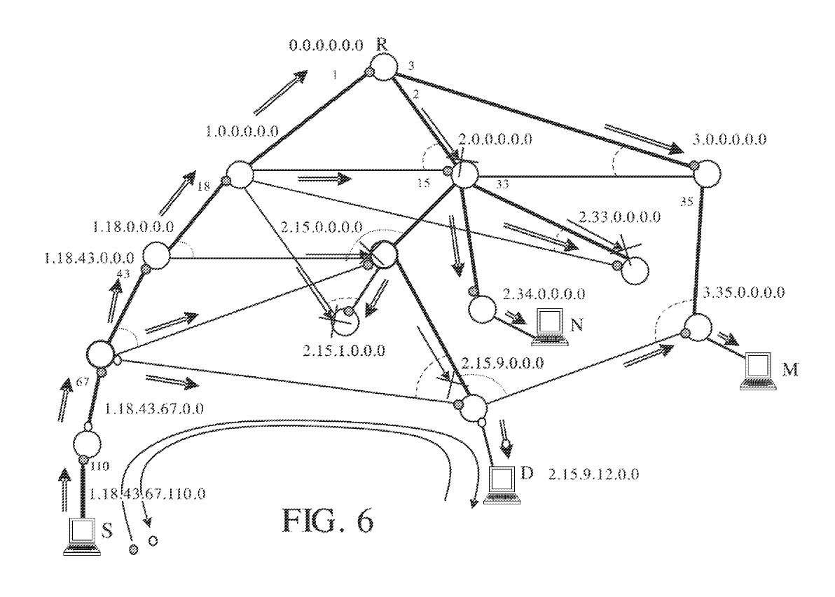

FIG. 6 shows an example of a transparent FastpathUD bridge network and the routing of frames using the FastpathUD paths of the network between stations. The transverse links are depicted with a fine line and those belonging to the spanning tree assigning the local addresses are depicted with a thick line, the prohibited turns in the broadcast of frames are indicated by means of a dotted arch between links, the arrow and cross symbols indicate the frames discarded due to arriving duplicated at the bridge—slower paths—, the double arrows indicate the frames traveling over the paths obtained by the FastPathUD protocol—faster paths—, and each black circle shows a learnt port captured by means of the learning process of the ports associated with the address of the source station of the frames.

In the example of FIG. 6, the host station S with hierarchical address 1.18.43.67.110.0 assigned according to distance to the root bridge sends a broadcast ARP frame to the entire network. The bridge 1.18.43.67.0 receives it, notes the address and associates it with the identity of the input port and blocks the register linking it, starting a blocking timer and an aging timer of the learnt address. It forwards the frame to the bridges connected thereto. FIG. 6 depicts that the bridge 2.15.9.0.0.0 receives the frame from 1.18.43.67 before from 2.15.0.0.0.0, therefore the address of the station is associated with the port marked with a black circle in the figure and the update of said entry is blocked for a guard interval. The bridge 2.15.9.0.0.0 delivers the frame to the station D. Other bridges, such as 2.34.0.0.0., deliver the frame to other hosts such as N and M, which likewise process it by checking if it is intended for them. Only the host D sends a reply frame, “ARP Reply”, with the address of the host S as the destination MAC address. The bridge 2.15.9.0.0.0 receives the frame and registers the association of the address of D with the input port, indicated by a white circle. In addition, it has the address learnt as associated with the port marked with the black circle and forwards it through said port, establishing the symmetrical backward path through which the address was learnt in the forward path.

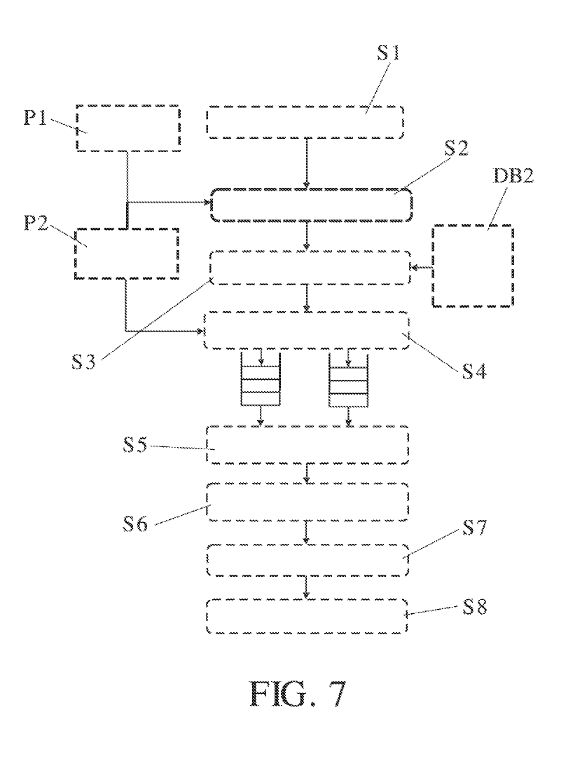

FIG. 7 shows a block diagram of the process for forwarding frames executed by the FastpathUD bridge and follows these steps:

Simultaneously to the reception S1 of the frames, the status of the source port P1 and that of the destination port P2 are consulted to execute the active topology S2, and then a filtering of frames S3 is performed according to the data from the cache DB2 implementing the blocking of the learning of the frame source address. After filtering frames S3, the latter pass to different queues, in a queuing step of frames S4 which takes into account the status of the source port P1 and that of the destination port P2. The frames to be transmitted S5 are selected from the queues of frames. The block S6 is in charge of the control of prohibited turns by preventing the forwarding through links involving prohibited turns. Before performing the transmission S8 of those frames, said frames are checked to detect errors S7, recalculating the FCS: Frame Check Sequence field.

The frames which are sent through the spanning tree by means of RSTP for the forwarding have a “VLAN T” tag as a VLAN identification, whereas the frames using the FastpathUD paths are tagged by means of a “VLAN F” VLAN identification. There can also be frames without a VLAN tag.

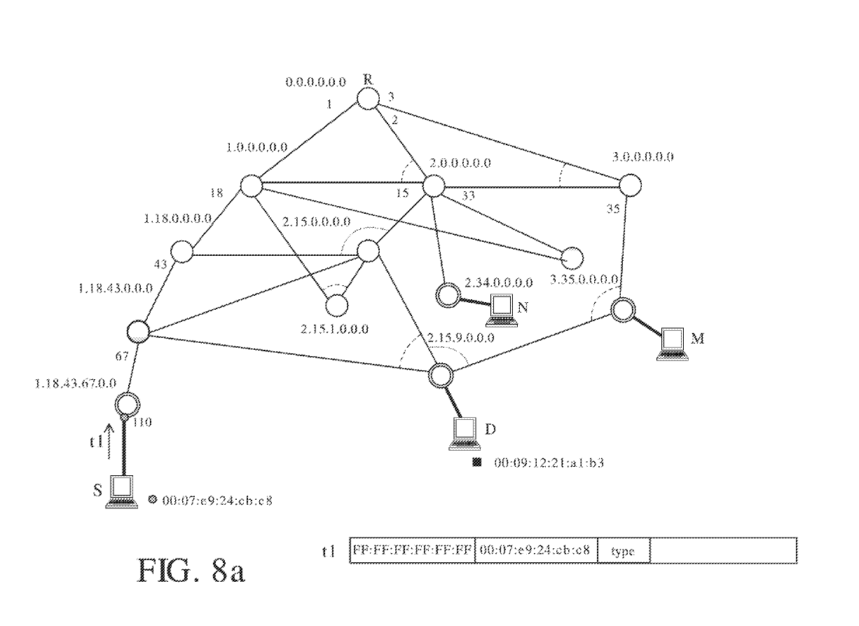

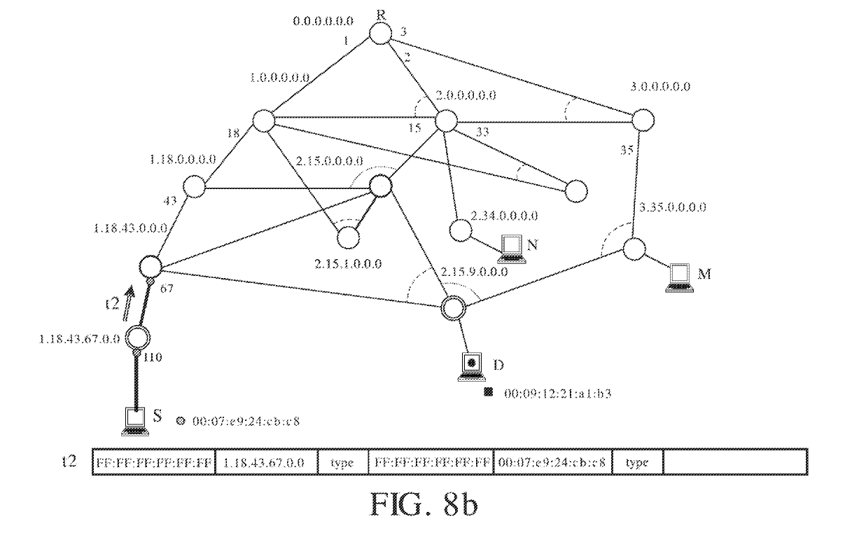

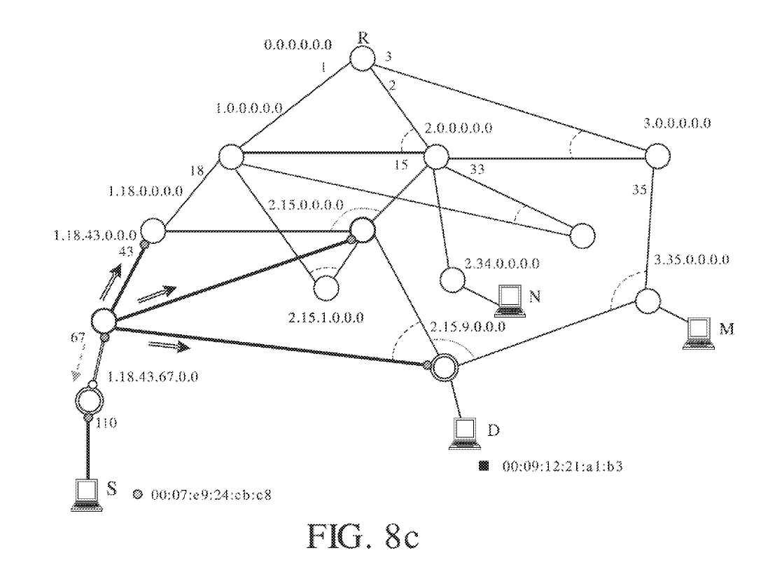

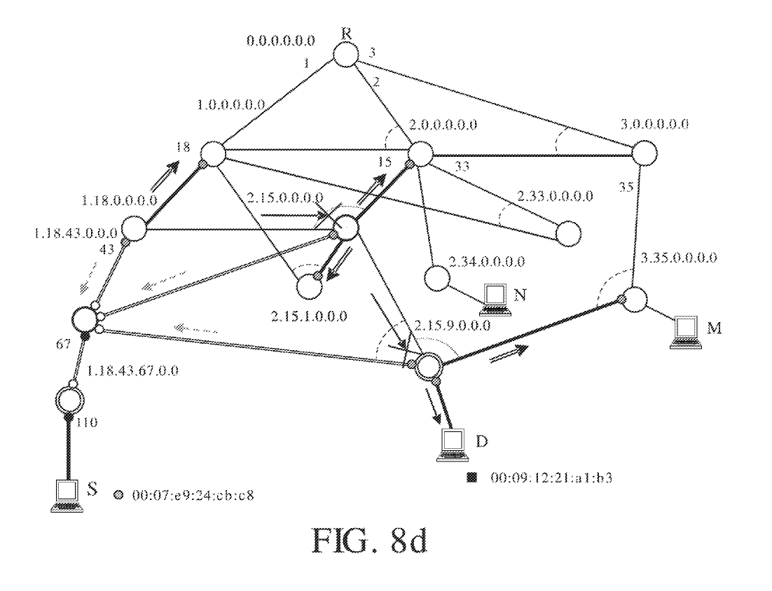

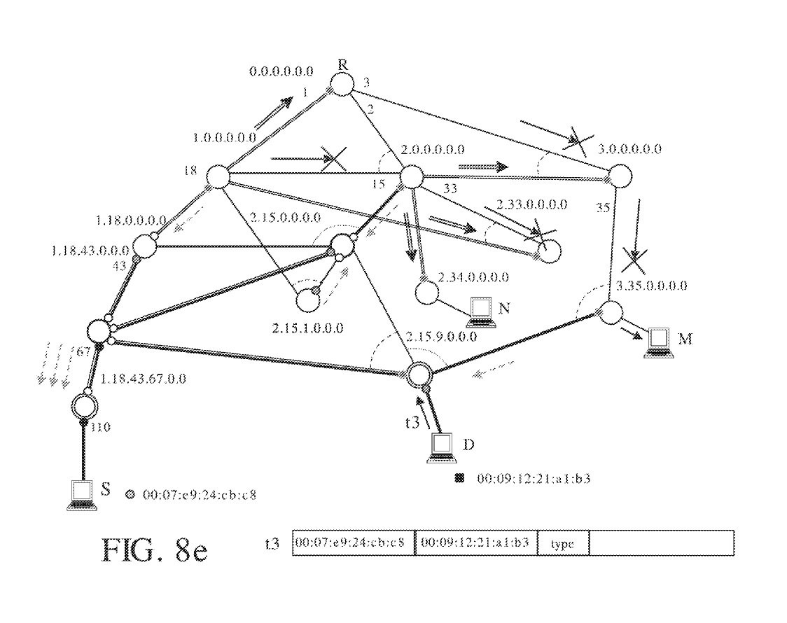

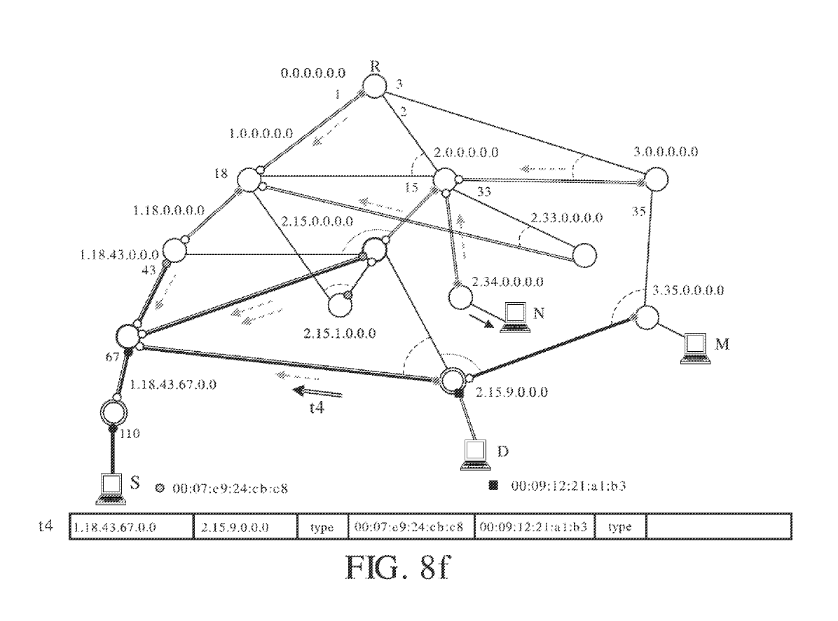

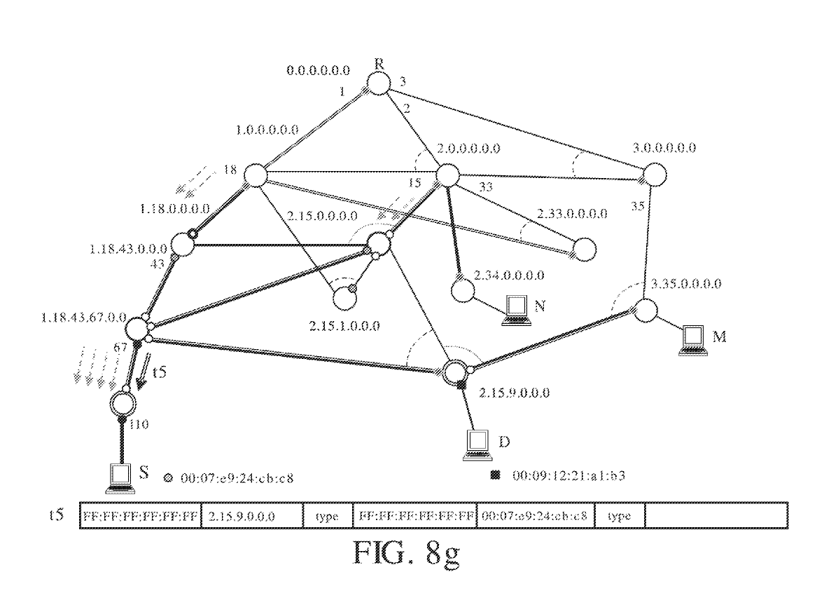

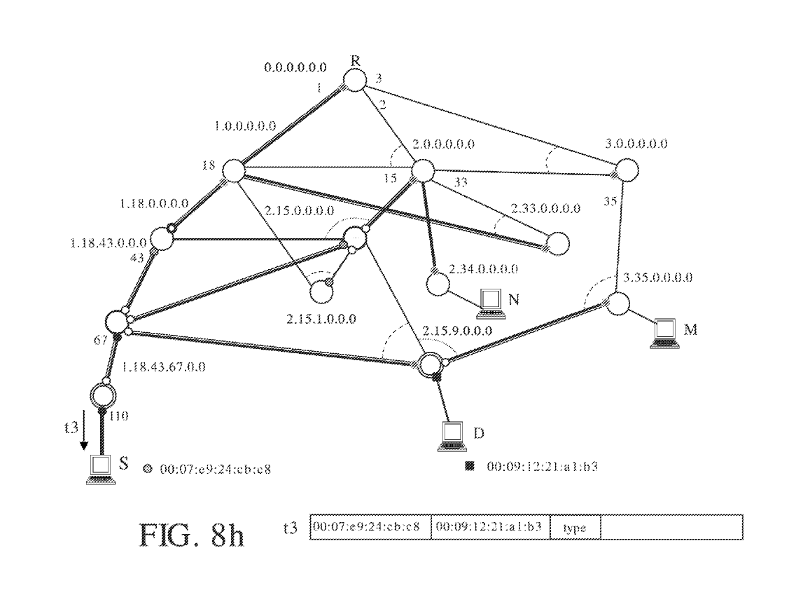

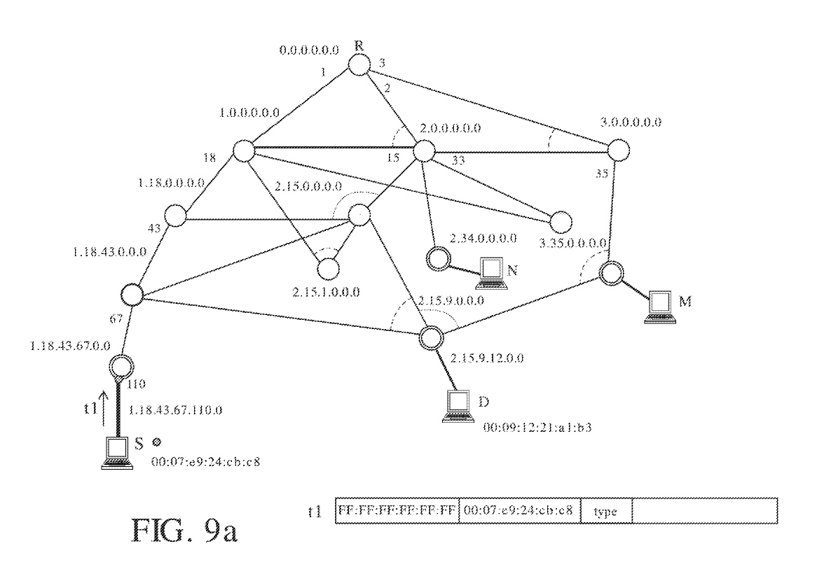

FIGS. 8 (a) to (h) illustrate the successive steps of the process for the establishment of a two-way or symmetrical path with an example using HLMAC addresses.

In FIG. 8 (a), a source terminal station S sends an Ethernet frame which does not require encapsulation, with the universal MAC address of the station S as a source MAC address and with the broadcast MAC address as a destination MAC address; in the example, the source UMAC address of the station S is 00:07:e9:24:cb:c8 and that of the destination station D is 00:09:12:21:a1:b3. The source border bridge with the HLMAC 1.18.43.67.110.0 does not know the UMAC of the station S until it reaches the frame t1, which it receives without encapsulation, as depicted in FIG. 8 (a) with the fine-line arrow. The frame t1 contains the layer-two broadcast address FF: FF: FF: FF: FF: FF.

Once the previous frame is received in the source border bridge 1.18.43.67.110.0 through the port 110, the border bridge encapsulates it in a frame t2 with source address 1.18.43.67.0.0 and learns the UMAC 00:07:e9:24:cb:c8 of the station S in the designated port 110. The frame t2 with the HLMAC encapsulation is sent, as depicted in FIG. 8 (b) with the double-line arrow, through the established paths; in the example a single link of the spanning tree to the following bridge 1.18.43.67.0.0.

FIGS. 8 (c) and (d) depict, with the double-line arrow, the transmission of the encapsulated frame t2 until reaching, through the fast paths, the destination station D, whereas the dotted-line arrow indicates the sending of the frames for the establishment of the symmetrical reverse path and the arrow with the cross corresponds to the discarding of frames in the slower paths.

Therefore, in FIG. 8 (e) the symmetrical paths between neighboring bridges (links drawn with a double line), as well as the symmetrical path to the source border bridge (links drawn with a double thick line), are established.

The station D sends its non-encapsulated Ethernet reply frame t3, as illustrated in FIG. 8 (e), which is encapsulated by the destination border bridge with its HLMAC 2.15.9.0.0.0. The Ethernet frame with the HLMAC encapsulation t4 is send to the source HLMAC address 1.18.43.67.0.0 and, from there, the frame t5 is sent through the symmetrical path to the source border bridge, as illustrated in FIGS. 8 (f) and (g). Finally, FIG. 8 (h) illustrates the reply frame t3 of the station D, corresponding to a “ARP Reply” frame, which reaches the station S.

The method shown in FIGS. 8 (a) and (h), with a reply of each crossed bridge, is optional—costly in messages—, although it is especially suitable for establishing paths between all the bridges.

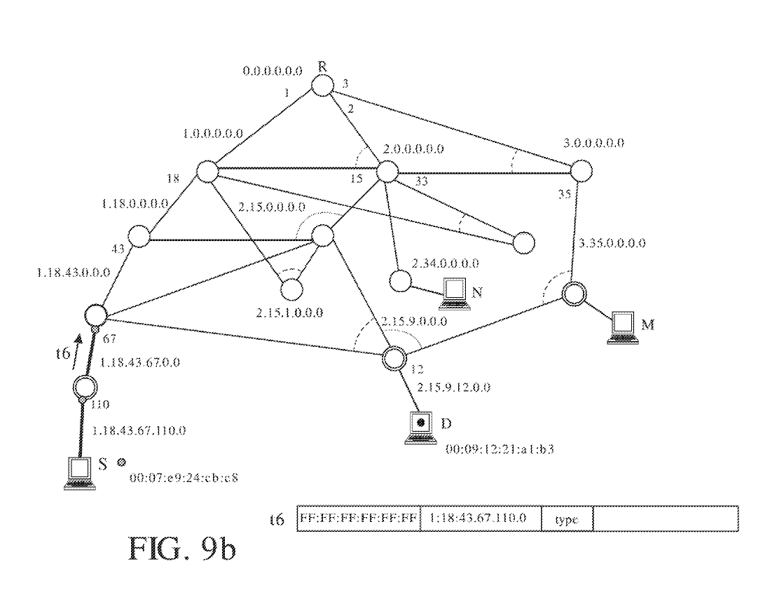

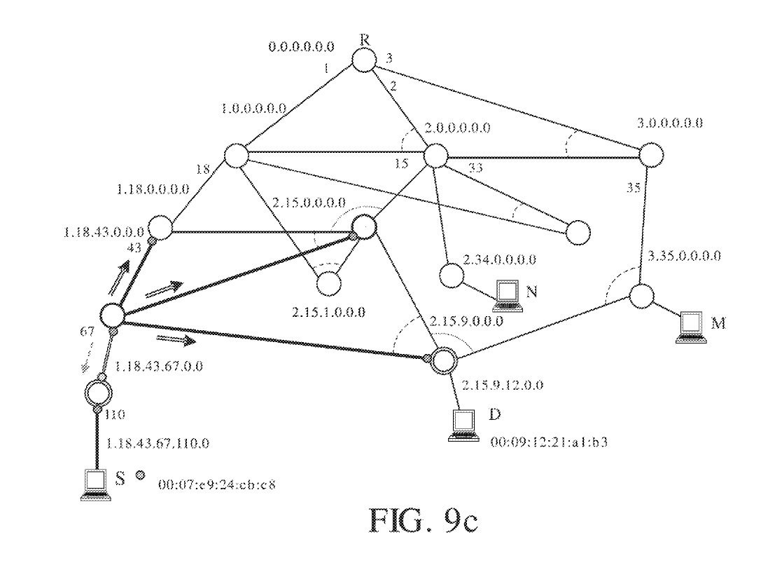

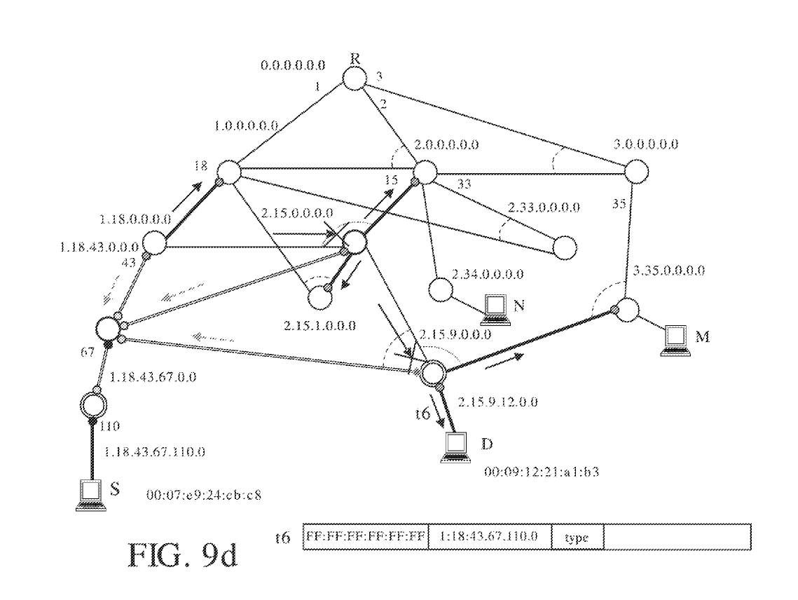

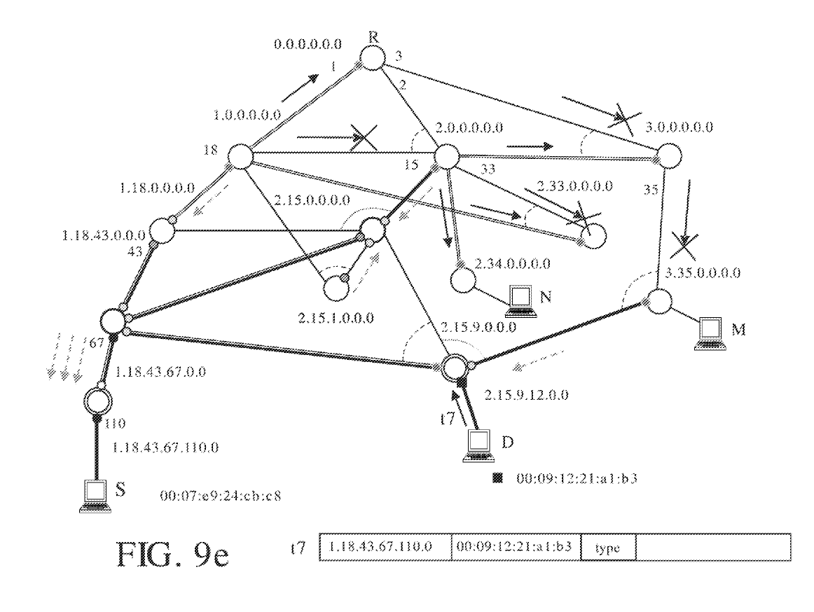

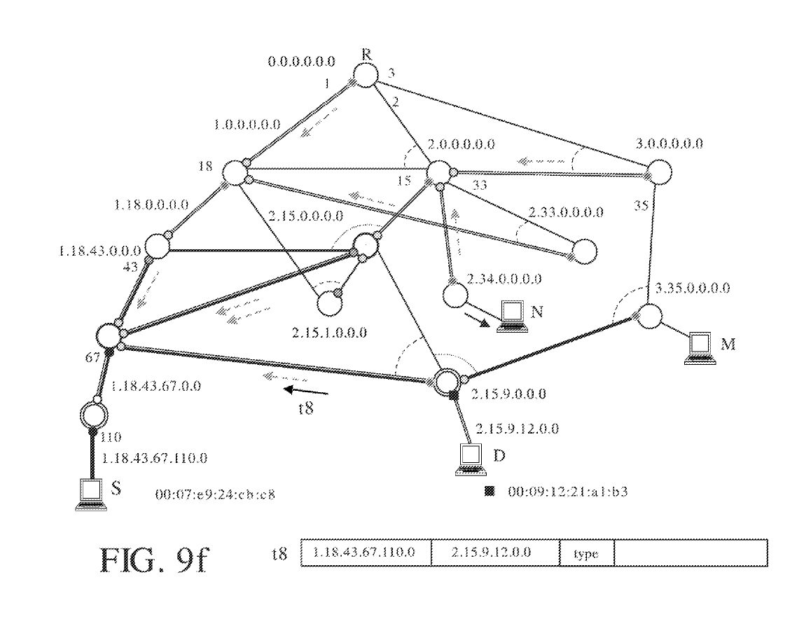

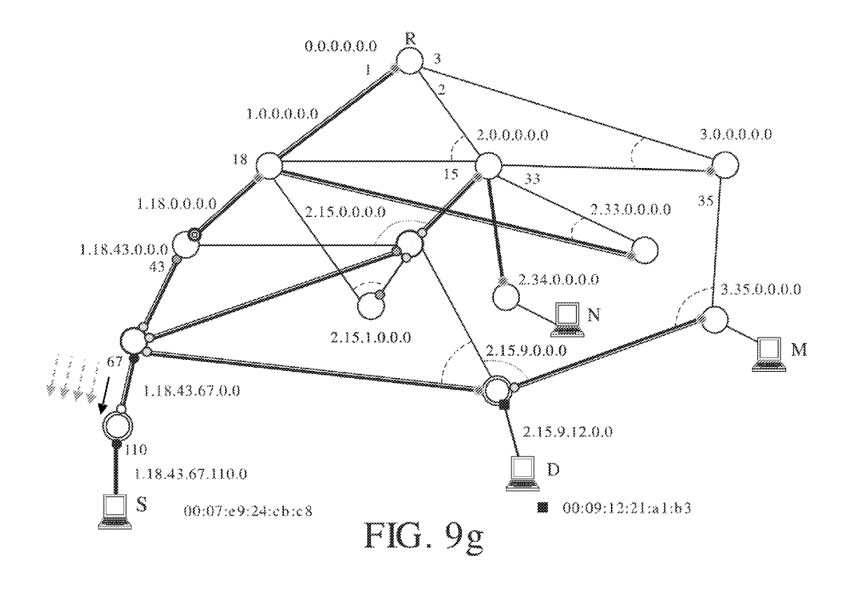

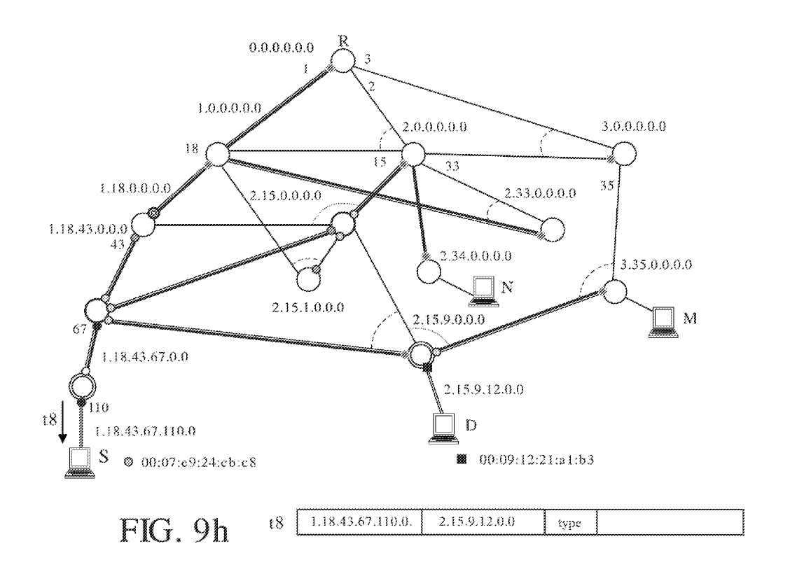

Another possible implementation of the establishment of paths is without using encapsulation and using the substitution of universal MAC addresses with local addresses in the border bridges, as shown in the successive steps illustrated in FIGS. 9 (a) to (h). In this implementation, the source station S starts sending the frame t1 using its UMAC, 00:07:e9:24:cb:c8 in the example of FIG. 9 (a), which is substituted in the source border bridge with the HLMAC, 1.18.43.67.110.0 in FIG. 9 (b), which carries the frame t6 to the destination station D, following the same path shown in FIGS. 9 (c) and (d). The discontinuous arrows show the optional agreement of paths of the intermediate bridges. The destination station D likewise uses its UMAC, 00:09:12:21:a1:b3 in FIG. 9 (e) for the reply frame t7, which is not encapsulated in its border bridge either, as shown in FIG. 9 (f), but rather it is sent as a reply frame t8, replacing the UMAC with the HLMAC of the port connecting the station D to the destination border bridge. The frame t8 follows the reverse path, as shown in FIGS. 9 (g) and (h), to the station S which receives the reply as is, without encapsulation and with the HLMAC addresses.

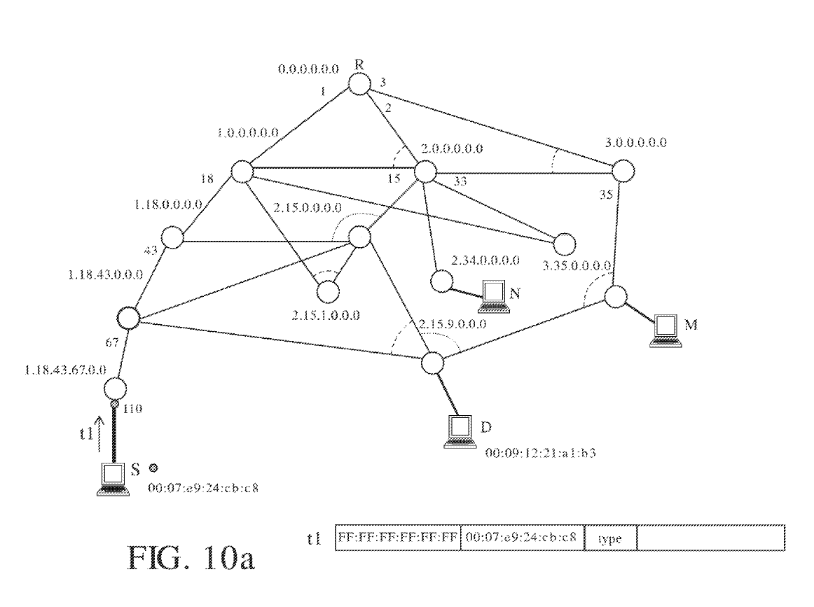

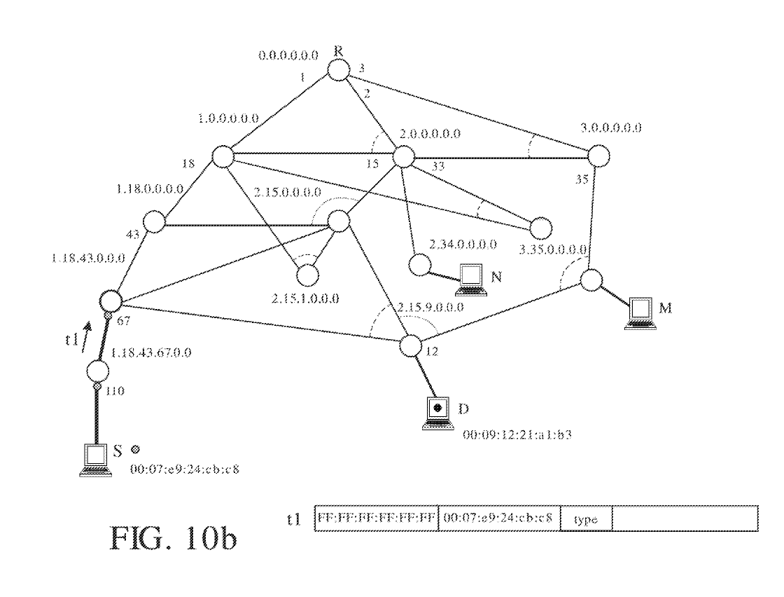

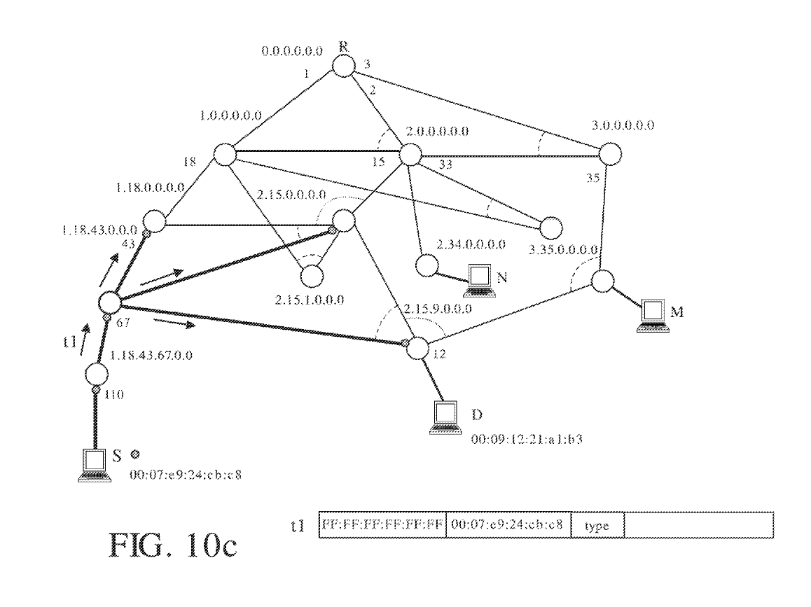

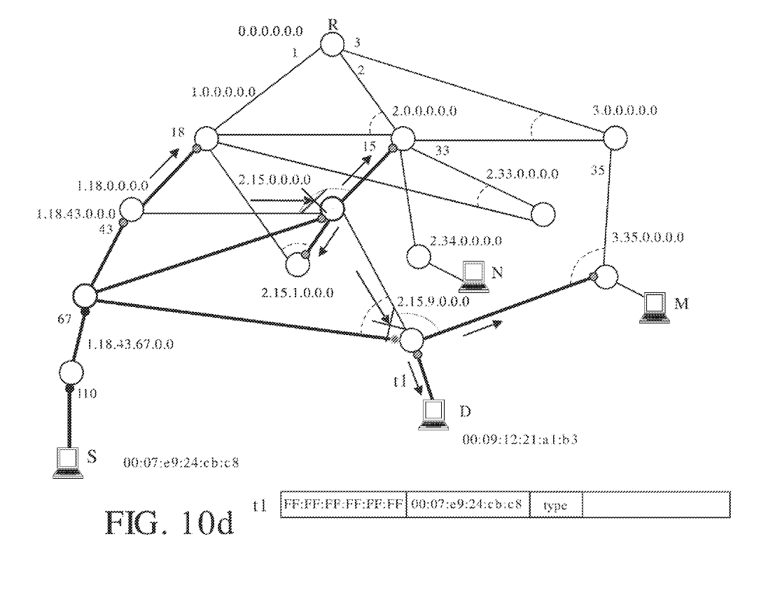

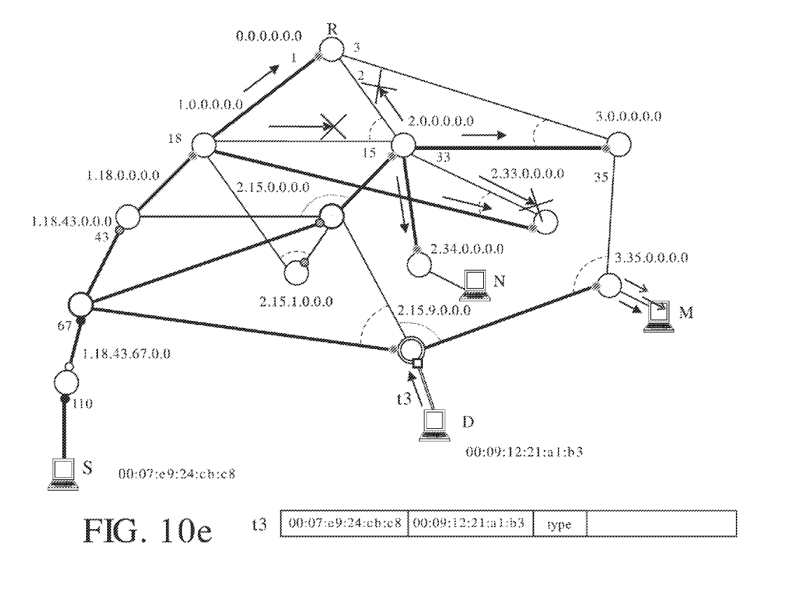

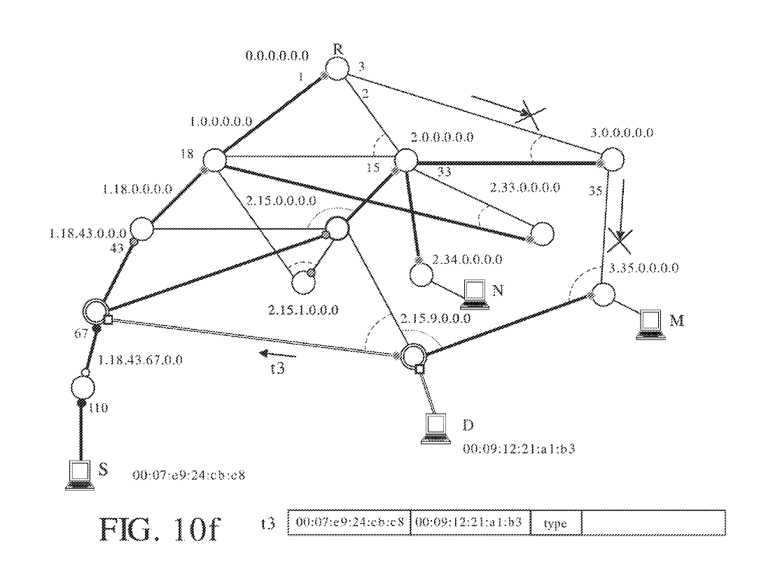

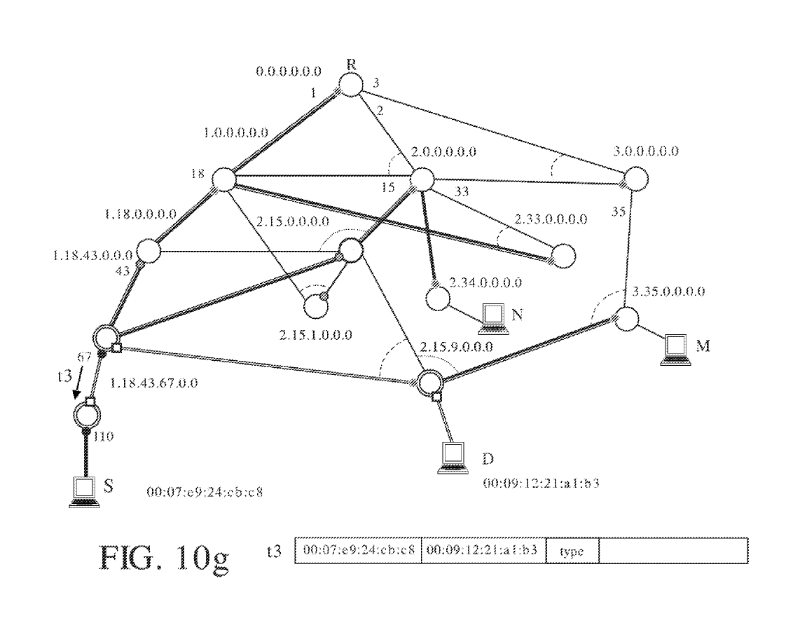

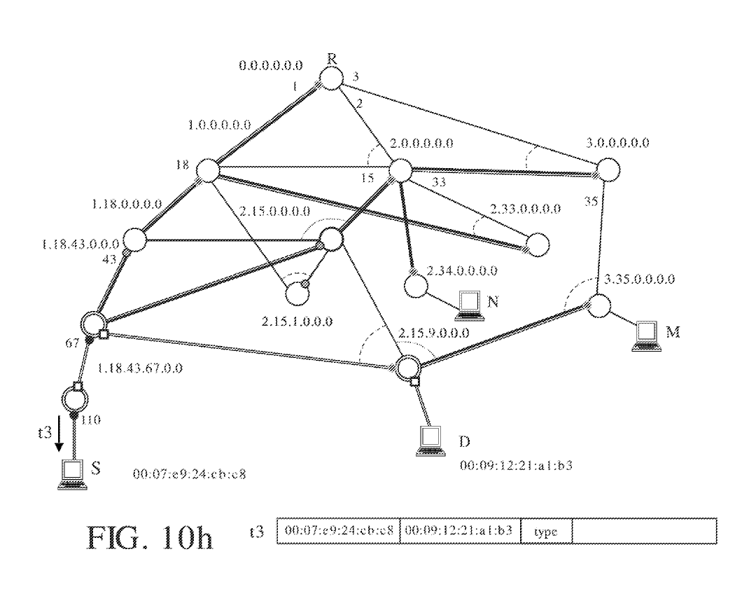

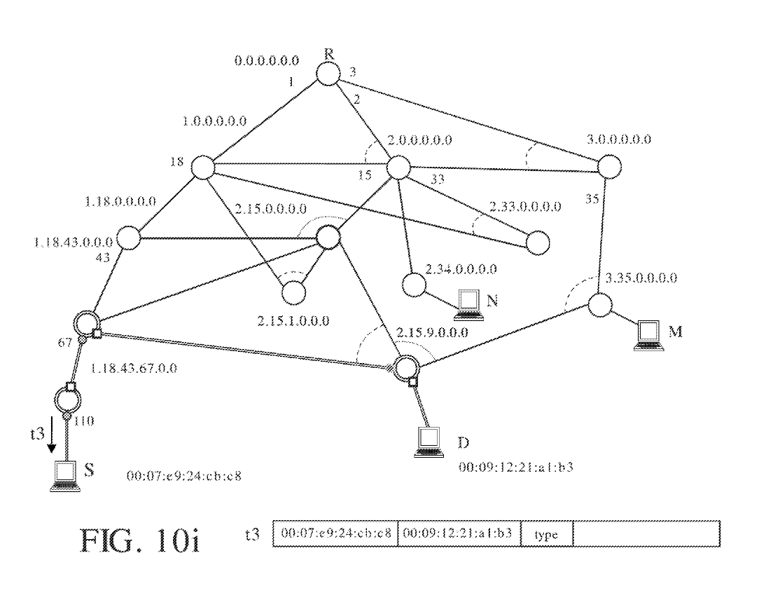

FIGS. 10 (a) to (i) illustrate another possible implementation of the establishment of paths, also without using encapsulation and using universal MAC addresses. The source station S in FIG. 10 (a) sends a frame t1 with source UMAC address 00:07:e9:24:cb:c8 and destination UMAC address 00:09:12:21:a1:b3 of the destination station D. The border bridge 1.18.43.67 did not know the UMAC address 00:07:e9:24:cb:c8 of the source station S connected thereto, therefore it is a bridge with an unconfirmed FastpathUD connection. The bridges with provisional FastpathUD connection are depicted in FIGS. 10 (a)-(i) as simple circles, whereas the bridges with confirmed FastpathUD connection are depicted with double circles.

In FIG. 10 (b), the bridge 1.18.43.67.110 receives the frame t1 and learns the UMAC address of the source station S in the port 110, and at the same time it initiates the guard time of that source UMAC address and forwards the frame t1 by means of FastpathUD broadcast through all the links which do not involve a prohibited turn. The following bridge in the tree does the same as the previous one, as indicated in FIG. 10 (c): the guard time of the source UMAC address in the port of the bridge through which it has been received is initiated and it is forwarded to all the bridges with allowed turn, the process being repeated in each bridge of the path until reaching the destination station D. In FIG. 10 (d), the frame t1 of the source station S reaches the destination D.

The destination station D replies to the frame t1 with an “ARP Reply” which is a unicast frame t3, with the UMAC of the station S as the destination address. As shown in FIG. 10 (e), the frame t3 reaches the bridge 2.15.9.0.0.0, which learns the UMAC address of the station D and confirms the capture of the pending UMAC address of S—confirmed Fastpath connection—. In FIG. 10 (f), the bridge 2.15.9.0.0.0 with the confirmed connection forwards the frame t3 through the port learnt or associated with the UMAC address of the station S towards the bridge 1.18.43.67.0.0, which upon receiving it also confirms its capture of the address of the station S, learns the established path and confirms it to the station D. The same processes are repeated in the following bridge 1.18.43.67.110, which is already the one connected to the station S, as shown in FIG. 10 (g). The frame t3 received in 1.18.43.67 is untagged from the “ULAN F” and forwarded to the station S, as shown in FIG. 10 (h). Finally, the guard time of the bridges which have not received the unicast reply elapses—bridges depicted in FIG. 10 (i) as simple gray circles— and, therefore, the provisional FastpathUD connections towards the station S are deleted. The double circles here indicate a confirmed connection—by backward unicast—.

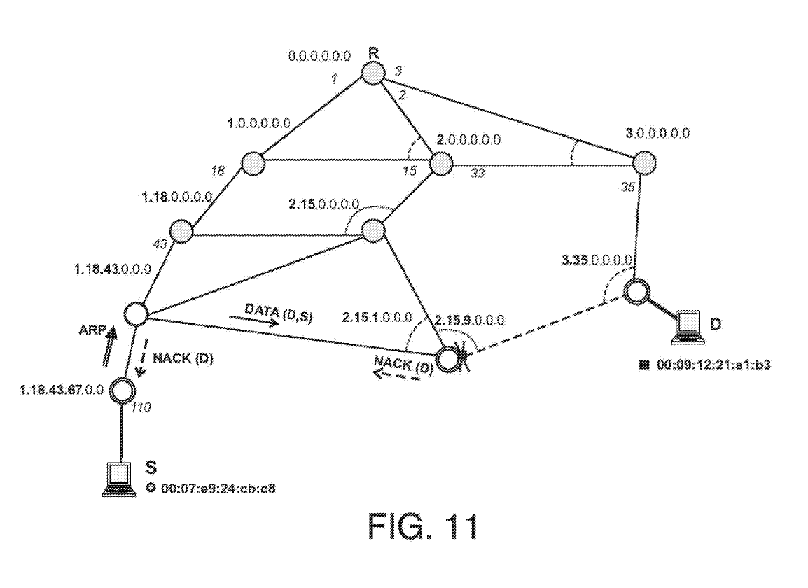

FIG. 11 shows the reconfiguration of the network in the event of failure of a link, for example, a transverse or cross-link, not belonging to the spanning tree, as is the case of FIG. 10. The crash of the link between the bridges 2.15.9.0.0.0 and 3.35.0.0.0.0 is detected by both of them, which put the addresses learnt by the ports connected to the link as unreachable. When the unicast data frame DATA (D, S) with the station S as the source and D as the destination reaches the bridge 2.15.9.0.0.0 through the previously learnt port, it finds that the port of that bridge connected to the crashed link has its learnt addresses in an “unreachable address” status. When the bridge 2.15.9.0.0.0 receives the frame intended for a now unreachable address, it returns an unlearning frame NACK(D) indicating the destination D to the source S, which sends a new ARP frame to reconfigure the path to the destination station D and connect it to a reachable port, for example that of the bridge 3.35.0.0.0.

In any of the implementations described, the establishment of paths by the border bridges has the advantage of route aggregation (by a factor of the order of up to 100, according to the number of ports provided in the border bridges) and a simple control of the path symmetry.

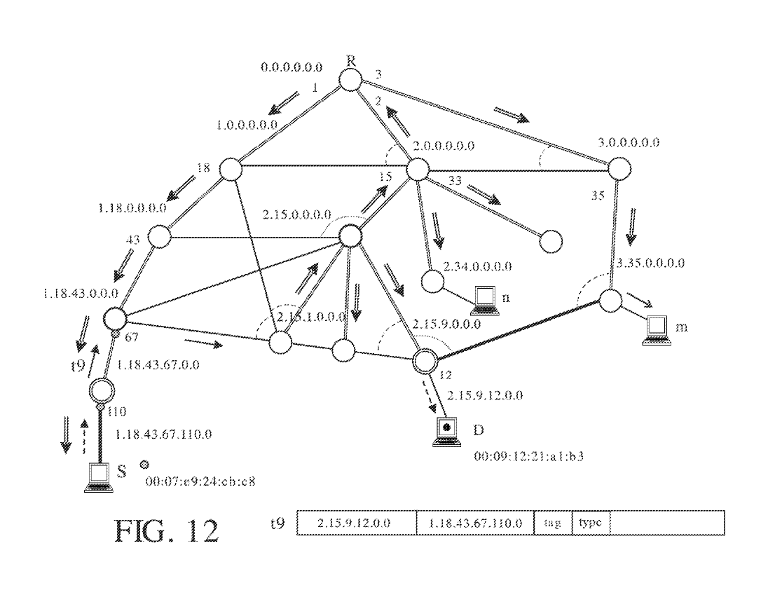

FIGS. 12 to 14 illustrate various possibilities for forwarding unicast frames with a destination address unknown by the bridge due to the aging of the address or a reconfiguration of the network. The node drawn with a striped interior represents the bridge reached by a unicast frame with an unknown unicast address.

FIG. 12 illustrates a general case, when a FastpathUD bridge receives a FastpathUD unicast frame t9 identified by its FastpathUD VLAN, i.e., with a “VLAN F” tag, but the bridge does not have any port associated with that address, i.e., there is no confirmed FastpathUD connection or path. The frame is thus reidentified with the VLAN of the spanning tree, i.e., with the “VLAN T” tag and rerouted through the RSTP standard spanning tree, as depicted in FIG. 12 by means of a double arrow. The frame is untagged to deliver it to the destination station D.

The frames without a VLAN tag are depicted in FIGS. 12 to 14 as dotted arrows.

The routing through the spanning tree can vary according to whether the frame has a HLMAC or UMAC address.

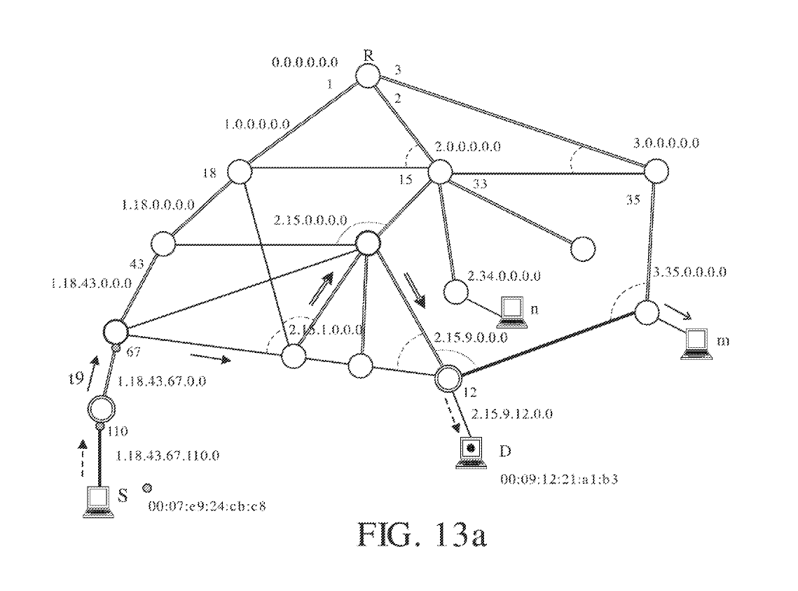

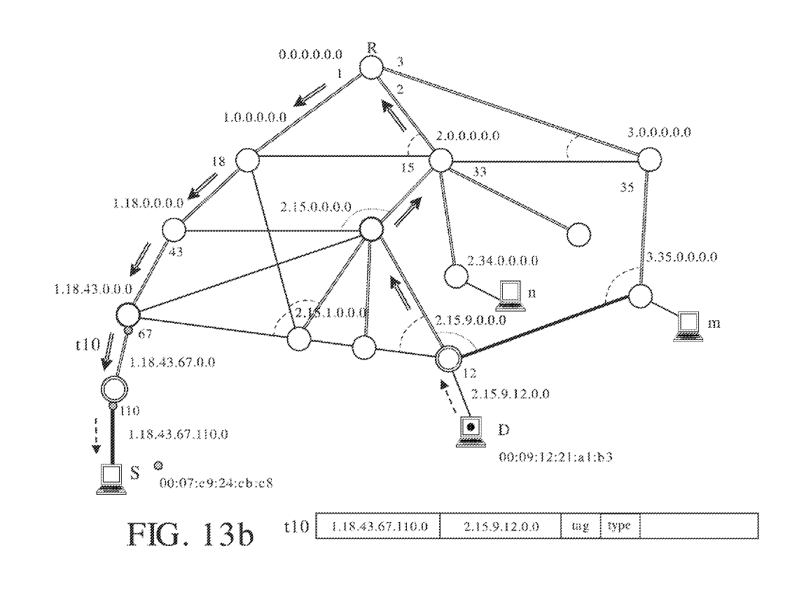

When HLMAC addresses are used, as in the example of FIGS. 13 (a) and 13 (b) which depict the routing of the frame in the forward and backward direction respectively, decoding the HLMAC addresses through the tree. The frame t9 can be routed without the need for broadcast, first ascending through the tree directly to the root bridge R, via the root port in all the bridges, to then descend through the branch corresponding to the destination host D, as shown in FIG. 13 (a), simply choosing in each bridge of the descending segment the port indicated by the HLMAC address. The bridge 2.15.1.0.0, which does not know the HLMAC address 2.15.9.12.0.0 due to the aging of the address or due to the unlearning of the port associated therewith by reconfiguration, encapsulates the frame t9 with a “VLAN T” tag and forwards it through the spanning tree.

If the destination host is in the same branch of the spanning tree as the bridge, it is not necessary to ascend to the root bridge R; it is enough to travel over the branch in an ascending or descending direction, decoding the destination

HLMAC address hop by hop.

For the backward path, shown in FIG. 13 (b), the border bridge 2.15.9.0.0.0 receives the reply frame t10 of the station D directed to the station S and tags the frame with “VLAN T” before sending it to the border bridge connected to the station S with HLMAC address 1.18.43.67.110.0. Since that destination address does not a common prefix with its bridge address, the frame t10 ascends through the tree via the root ports to the root bridge R. In the root bridge R, the HLMAC address is decoded in each stage, choosing the first port of the non-matching suffix between the bridge HLMAC address and the destination HLMAC address.

When UMAC addresses are used, the frames are broadcast in the 802.1D standard manner through the active ports of the spanning tree. This broadcast is performed without learning of the source MAC address. The reply or backward frame from the destination host uses the spanning tree in the standard manner, broadcasting the backward frame through the entire tree until reaching the destination host. Each border bridge receiving a unicast frame through spanning tree cancels any association with a port that it has in that bridge associated with the source or destination address, thus deleting the associated Fastpath routes. The destination border bridge does the same, whereby successive forward unicast frames will travel over the spanning tree until a new FastpathUD connection is established between the source and destination.

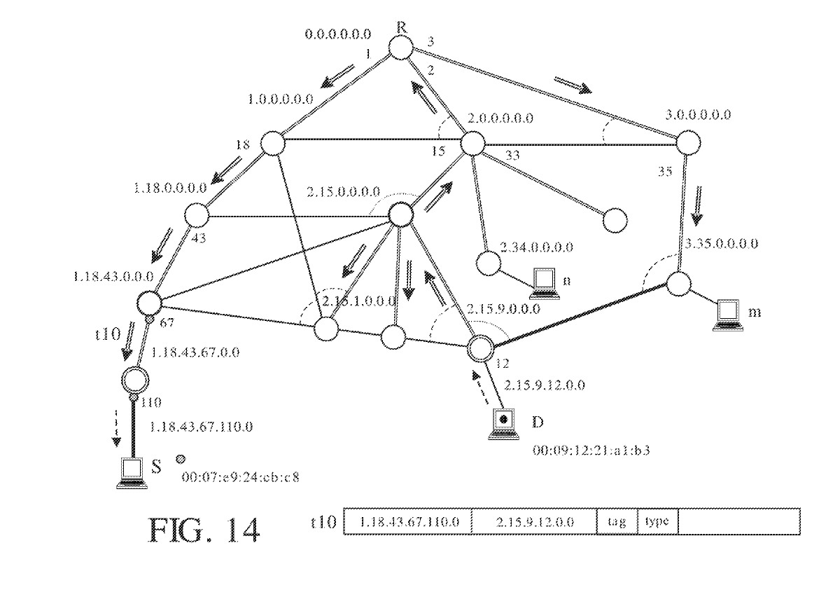

FIG. 14 illustrates a case in which the backward path of the frame t10 is performed without learning of the source MAC address. The border bridge 2.15.9.0.0.0 receives the frame t10 directed to 1.18.43.67.110.0, which has associated therewith the “ULAN T” tag of the spanning tree and, with that tag, it forwards the frame t10 through all the active ports in each bridge of the tree, until reaching the root bridge R and from there is broadcast downwards through the entire tree.

In this text, the word “comprises” and its variants (such as “comprising”, etc.) must not be interpreted in an exclusive manner, i.e., they do not exclude the possibility that what is described includes other elements, steps, etc.

In addition, the invention is not limited to the specific embodiments described herein, but rather it also encompasses the variants which can be made by the person having ordinary skill in the art (for example, in relation to criteria of configuration and size of the telecommunications networks, size of the data structures, etc.), without departing from the scope of the invention which is inferred from the claims included below.

1. A method for routing data frames through a plurality of multiport network bridges connected by point-to-point links supporting two propagation directions, forming a spanning tree from a root network bridge with respect to which each network bridge has a distance, the method comprising:
assigning to each network bridge of the spanning tree an address in correspondence with the distance to the root network bridge,
receiving in a network bridge a frame containing a source media access control (MAC) address, through a port of the bridge having a port identity assigned thereto,
associating in the bridge the identity of the port which first receives the frame with the source MAC address of the frame, with an expiration indicator of the source MAC address and with a guard time during which the source MAC address-identity of the port association is maintained unmodifiable,
discarding through the network bridge all frames with the same source MAC address received through a port of the bridge with a port identity different from that of the source MAC address-identity of the port association.

2. The method according to claim 1, wherein if the received frame contains a broadcast destination MAC address, the method further comprises sending the frame through all the ports of the bridge having a port identity different from that of the identity of the port-source MAC address of the frame association.

3. The method according to claim 1, wherein if the received frame contains a unicast MAC address different from the source MAC address of the source MAC address-identity of the port association of each and every one of the ports of the bridge which receives the frame, the method further comprises modifying the received frame by substituting the unicast MAC address with the source MAC address of the received frame and sending the modified frame through the port of the bridge through which the modified frame has been received.

4. The method according to claim 1, wherein if the received frame contains a unicast MAC address identical to the source MAC address of the source MAC address-identity of the port association and the aging indicator indicates that the address is aged out, the method further comprises modifying the received frame by substituting the unicast MAC address with the source MAC address of the received frame and sending the modified frame through the port of the bridge through which the modified frame has been received.

5. The method according to claim 3, further comprising:
receiving the modified frame in a border bridge connected to a host having the destination address contained in the modified frame,
sending from the border bridge a frame with a broadcast destination MAC address and source MAC address identical to the address of the border bridge,
receiving the frame with broadcast destination MAC address in a network bridge through a port and modifying the frame by substituting the source MAC address with the address of the network bridge and the broadcast destination MAC address with the address of the border bridge,
sending from the bridge the frame with source MAC address identical to the address of the bridge through the port the port identity of which is that of the source MAC address-identity of the port in the bridge association.

6. The method according to claim 1, further comprising: periodically sending tracer frames between two border bridges, including a sending source border bridge which sends and a receiving destination border bridge which receives the tracer frames containing a source address identical to the address of the sending border bridge through a link in the two propagation directions.

7. The method according to claim 6, wherein the tracer frames contain a destination address which is identical to the address of the receiving border bridge.

8. The method according to claim 6, wherein the tracer frames contain a destination address which is a broadcast address.

9. The method according to claim 1, wherein the method uses the address resolution protocol (ARP).

10. The method according to claim 1, wherein if the received frame contains a source MAC address which is a universal MAC address and a unicast MAC address which has associated therewith in the bridge receiving the frame an aging indicator indicating that the address is aged out, the method further comprises:
deleting from the bridge the association with the unicast MAC address,
modifying the received frame by substituting the unicast MAC address with a multicast MAC address,
sending the modified frame to the source MAC address.

11. A multiport network bridge further comprising processing means configured to route frames at the data link level and in the user plane according to the method for routing data frames defined according to claim 1.

12. A switched telecommunications network, further comprising at least one network bridge defined according to claim 11 connected to a root network bridge in a spanning tree.
